(19) United States
(12) Patent Application Publication
(10) Pub. No.: US 2026/0224983 A1
(43) Pub. Date: Aug. 6, 2026

(54) ONE OR MORE COMPUTER-READABLE STORAGE MEDIA, GAME SYSTEM, AND COMPUTER-IMPLEMENTED METHOD

(71) Applicant: NINTENDO CO., LTD., Kyoto (JP)

(72) Inventors: Toshiaki SUZUKI, Kyoto (JP); Tatsumitsu WATANABE, Tokyo (JP)

(21) Appl. No.: 19/636,452

(22) Filed: Apr. 1, 2026

Related U.S. Application Data
(63) Continuation of application No. PCT/JP2023/037063, filed on Oct. 12, 2023.

(51) Int. Cl. A63F 13/428; A63F 13/55; G06F 3/0354

(52) U.S. Cl. CPC A63F 13/428; A63F 13/55; G06F 3/03543

(57) ABSTRACT

A first process of moving a first object along a virtual surface in a virtual space based on first data output according to movement of a first mouse on a placement surface is executed. A second process of moving the first object along the virtual surface based on second data output according to lift of the first mouse from the placement surface is executed.

### CROSS REFERENCE TO RELATED APPLICATION

This application is a continuation of International Patent Application No. PCT/JP2023/037063, filed on October 12, 2023, the entire contents of which are incorporated herein by reference.

### FIELD

The technology disclosed herein relates to storage media, game systems, and computer-implemented methods, and more particularly, to one or more computer-readable storage media, a game system, and a computer-implemented method that are used in a process in which a mouse is used, for example.

### BACKGROUND AND SUMMARY

There has conventionally been a video game apparatus that executes a game using a pointing device such as a mouse, as an input apparatus.

However, there has been room for improvement in the amusingness of such a video game apparatus in terms of an operation method using a mouse. The present example discloses one or more computer-readable storage media, a game system, and a computer-implemented method that are capable of providing novel operation experience and amusingness.

The present example may have the following features (1) to (11), for example.

(1) An example configuration of one or more computer-readable storage media according to the present example have stored therein instructions that, when executed, cause one or more processors to perform operations comprising: executing a first process of moving a first object along a virtual surface in a virtual space based on first data output according to movement of a first mouse on a placement surface; and executing a second process of moving the first object along the virtual surface based on second data output according to lift of the first mouse from the placement surface.

With the configuration of (1), when the operation of lifting the first mouse from the placement surface is performed, the first object can be moved along the virtual surface in the virtual space, and therefore, novel operation experience and amusingness can be provided.

(2) In the configuration of (1), after the first object is moved along the virtual surface in the first process, the first object may be returned to a position before the movement of the first object, based on the second data, in the second process.

With the configuration of (2), the operation of lifting the first mouse from the placement surface is suitable for the case in which the operation of moving the first object from the position before the movement of the first object is repeatedly performed.

(3) In the configuration of (1), after the first object is moved along the virtual surface in the first process, the first object may be returned to a range including a position before the movement of the first object, based on the second data, in the second process.

With the configuration of (3), amusingness can be improved by returning the first object into a predetermined range by the second process, compared to the case in which the first object is returned to the same position.

(4) In the configuration of (1), in the second process, the first object may be moved to a position along the virtual surface based on a position where the first object is positioned at the time when the first mouse is lifted from the placement surface, based on the second data.

With the configuration of (4), the operation performed according to the movement of the first mouse on the placement surface is related to a position to which the first object is moved in the second process, and therefore, novel operation experience can be achieved in general operations of the first object.

(5) In the configuration of (1), in the first process, the first object may be moved on a path along the virtual surface based on the first data. In the second process, the first object may be returned to a position on the path based on the second data.

With the configuration of (5), an operation suitable for movement control for moving the first object back and forth on a predetermined path is provided.

(6) In the configuration of any one of (2) to (5), in the first process, a first in-game effect may be produced according to the movement of the first object. In the second process, the first in-game effect may not be produced according to the movement of the first object.

With the configuration of (6), in the case in which the first in-game effect is produced according to the movement of the first process, the first object is moved back to approach the position before the movement of the first object, by the operation of lifting the first mouse from the placement surface, whereby the operation that produces the first in-game effect can be more easily repeatedly performed.

(7) In the configuration of (6), the first mouse may include at least one operation button. The first in-game effect may be produced when the operation button is being operated.

With the configuration of (7), the production of the first in-game effect can be switched on or off, depending on the operation of the operation button.

(8) In the configuration of any one of (1) to (7), in the second process, the first object may be moved in a direction related to an orientation that the first mouse has at the time when the first mouse is lifted from the placement surface, based on the second data.

With the configuration of (8), a novel operation including the orientation of the first mouse can be achieved in the operation of lifting the first mouse from the placement surface.

(9) In the configuration of any one of (1) to (8), the operations may further comprise: executing a third process of moving a second object along the virtual surface based on fourth data output according to movement of a second mouse on a placement surface; and executing a fourth process of moving the second object along the virtual surface based on fifth data output according to lift of the second mouse from the placement surface.

With the configuration of (9), novel operation experience and amusingness can be further provided by employing both the operation of lifting the first mouse from the placement surface and the operation of lifting the second mouse from the placement surface.

(10) In the configuration of (9), the first and second objects may be a portion of a third object. In the first and third processes, the third object may be moved along the virtual surface.

With the configuration of (10), a single entire object can be moved by performing an operation of using the first and second mice to move the respective portions of the object.

(11) In the configuration of (10), in the second and fourth processes, the third object may not be moved.

With the configuration of (11), only a portion of an object can be moved by performing the operation of lifting the first or second mouse from the placement surface.

In addition, the present example may be carried out in the forms of a game system and a computer-implemented method. An example of one or more computer-readable storage media according to the present example may store instructions that, when executed, cause one or more processors of an information processing apparatus to execute the above processes.

According to the present example, novel operation experience and amusingness can be provided.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a block diagram showing a non-limiting example of a configuration of an information processing system 1 according to the present example,

FIG. 2 is a diagram showing a non-limiting example of an appearance of an input apparatus 3,

FIG. 3 is a diagram showing a non-limiting example of an operation of lifting an input apparatus 3 from a placement surface,

FIG. 4 is a diagram showing another non-limiting example of an operation of lifting an input apparatus 3 from a placement surface,

FIG. 5 is a diagram showing a non-limiting example of a game image that is displayed according to an operation performed on an input apparatus 3 in the first half of a first example game process,

FIG. 6 is a diagram showing a non-limiting example of a game image that is displayed according to an operation performed on the input apparatus 3 in the second half of the first example game process,

FIG. 7 is a diagram showing a non-limiting example of a game image that is displayed according to an operation performed on an input apparatus 3 in the first half of a second example game process,

FIG. 8 is a diagram showing a non-limiting example of a game image that is displayed according to an operation performed on the input apparatus 3 in the second half of the second example game process,

FIG. 9 is a diagram showing a non-limiting example of a game image that is displayed according to an operation performed on an input apparatus 3 in the first half of a third example game process,

FIG. 10 is a diagram showing a non-limiting example of a game image that is displayed according to an operation performed on the input apparatus 3 in the second half of the third example game process,

FIG. 11 is a diagram showing a non-limiting example of a game image that is displayed according to an operation performed on an input apparatus 3 in the first stage of a fourth example game process,

FIG. 12 is a diagram showing a non-limiting example of a game image that is displayed according to an operation performed the input apparatus 3 in the second stage of the fourth example game process,

FIG. 13 is a diagram showing a non-limiting example of a game image that is displayed according to an operation performed on the input apparatus 3 in the third stage of the fourth example game process,

FIG. 14 is a diagram showing a non-limiting example of positions to which a left hand POL and a right hand POR of a player object PO are returned,

FIG. 15 is a diagram showing another non-limiting example of positions to which a left hand POL and a right hand POR of a player object PO are returned,

FIG. 16 is a diagram showing another non-limiting example of positions to which a left hand POL and a right hand POR of a player object PO are returned,

FIG. 17 is a diagram showing a non-limiting example of main data and programs stored in a storage unit 22 of an information processing apparatus 2,

FIG. 18 is a flowchart showing a non-limiting example of a process that is executed in an information processing apparatus 2,

FIG. 19 is a subroutine showing a non-limiting specific example of a mouse sensor operation motion control process in step S53 of FIG. 18, and

FIG. 20 is a subroutine showing a non-limiting specific example of an inertial sensor operation motion control process in step S54 of FIG. 18.

### DETAILED DESCRIPTION OF NON-LIMITING EXAMPLE EMBODIMENTS

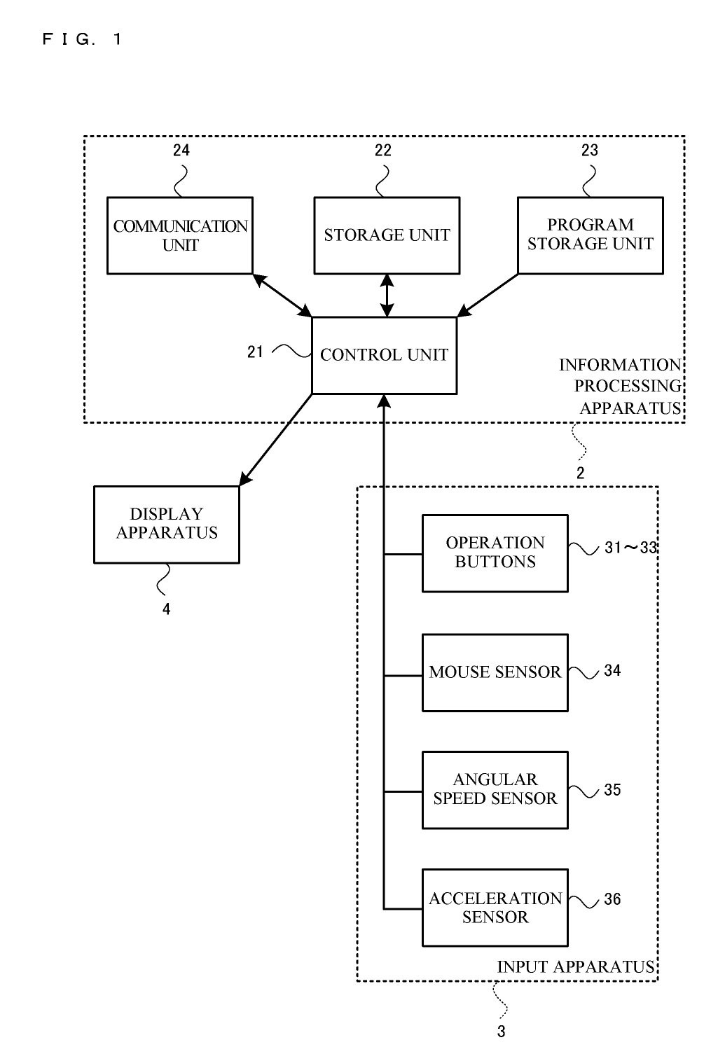

An information processing system 1 according to the present example will be described with reference to FIG. 1. As shown in FIG. 1, the information processing system 1 includes an information processing apparatus 2, an input apparatus 3, and a display apparatus 4, which are connected to each other wirelessly or by a cable. For example, in the information processing system 1, a process is executed by the information processing apparatus 2 based on an output of the input apparatus 3 that is produced when the input apparatus 3 is operated by the user, and a result of the execution is displayed on the display apparatus 4. It should be noted that the information processing system 1 may have a plurality of input apparatuses 3 connected to the information processing apparatus 2 wirelessly or by a cable. In that case, the plurality of input apparatuses 3 may be operated by the same user or different users.

The information processing apparatus 2 is configured to be able to connect to a network through wireless or wired communication and thereby configured to be able to connect to and communicate with other apparatuses (e.g., a server and another information processing apparatus 2). The information processing apparatus 2 is able to execute a predetermined application (e.g., a game application). For example, the information processing apparatus 2 is able to execute an information processing program that is stored in a storage medium such as a removable memory card or optical disc, or that is received from another apparatus. The information processing apparatus 2 may be a device such as a typical personal computer, stationary game machine, mobile telephone (smartphone), handheld game, or personal digital assistant (PDA).

The information processing apparatus 2 includes a control unit 21, a storage unit 22, a program storage unit 23, and a communication unit 24. It should be noted that the information processing apparatus 2 may be composed of one or more apparatuses including an information processing apparatus including at least the control unit 21, and another apparatus.

The control unit 21 is an information processing means (computer) for executing various information processes, e.g., a CPU. For example, the control unit 21 has the function of executing a game process described below, a process of transmitting and receiving data to and from another apparatus, and the like by executing the above application as the various information processes. Each function of the control unit 21 is carried out by the CPU executing a predetermined program.

The storage unit 22 stores various types of data that are used when the control unit 21 executes the above information processes. The storage unit 22 is, for example, a memory that can be accessed by a CPU (e.g., the control section 21).

The program storage unit 23 stores programs. The program storage unit 23 may be any storage apparatus (storage medium) that can be accessed by the control unit 21. For example, the program storage unit 23 may be a storage device included in the information processing apparatus 2 including the control unit 21, or a storage medium that is removably attached to the information processing apparatus 2 including the control unit 21. In addition, the program storage unit 23 may be a storage apparatus that is connected to the control unit 21 via a network (e.g., a server). The control unit 21 (CPU) may read all or a portion of an information processing program or game program into the storage unit 22 with appropriate timing, and execute the read program.

The communication unit 24, which includes a predetermined communication module, exchanges data with other apparatuses (e.g., a server and another information processing apparatus 2) via a network, or directly exchanges data with another information processing apparatus 2 (e.g., local communication).

In the case in which the information processing apparatus 2 is configured as a stationary game apparatus or a personal computer, the display apparatus 4 may be separated from the information processing apparatus 2. In another example, the display apparatus 4 may be integrated with the body of the information processing apparatus 2.

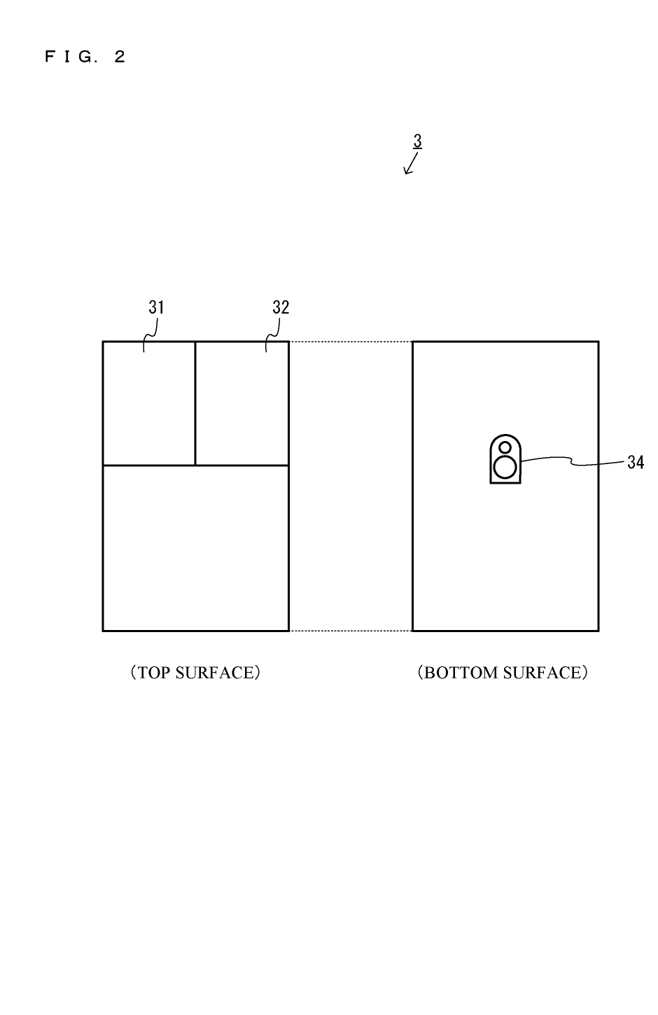

As shown in FIG. 2, the input apparatus 3 has the mouse function. As used herein, an input apparatus having the mouse function is referred to as a “mouse”. Here, the mouse function includes at least the function of outputting operation data indicating the movement direction and movement distance of the input apparatus 3 according to movement of the body of the input apparatus 3 on a surface where the input apparatus 3 is placed (hereinafter referred to as a “placement surface”) with the bottom surface of the input apparatus 3 facing the placement surface. The information processing apparatus 2 may, for example, move a cursor or the like displayed on the display apparatus 4 based on the operation data.

The input apparatus 3 includes a mouse sensor 34 for carrying out the mouse function. The mouse sensor 34, which is, for example, an optical sensor using an LED, may be similar to a sensor that is used in conventional mice. The mouse sensor 34 may, for example, be a sensor that uses laser light or infrared light. In the present example, the mouse sensor 34 is disposed in the body of the input apparatus 3 at a position where the mouse sensor 34 is exposed to the outside through a through hole formed in the bottom surface. When the input apparatus 3 is placed on the placement surface with the bottom surface of the input apparatus 3 facing the placement surface, the mouse sensor 34 emits light to the placement surface, detects light reflected from the placement surface, and executes an image process to calculate parameters (e.g., a movement direction and a movement distance) related to the movement of the input apparatus 3. It should be noted that the calculation of the parameters based on the result of the detection of the reflected light may be performed in the input apparatus 3 or in the information processing apparatus 2 if the information processing apparatus 2 receives, from the input apparatus 3, information about the result of the detection of the reflected light.

It should be noted that the input apparatus 3 may calculate a parameter related to the current position of the input apparatus 3 with respect to a reference position based on the result of the detection of the reflected light in the mouse sensor 34, in addition to or instead of the parameters related to the movement direction and movement distance of the input apparatus 3, and output the parameter related to the current position to the information processing apparatus 2. It should be noted that the calculation of the parameter related to the position may be performed in the input apparatus 3, or in the information processing apparatus 2 if the information processing apparatus 2 receives the result of the detection of reflected light from the input apparatus 3.

In addition, the input apparatus 3 may calculate a parameter related to the orientation of the input apparatus 3 based on the result of the detection of the reflected light in the mouse sensor 34, in addition to or instead of the parameters related to the movement direction and movement distance of the input apparatus 3 and the parameter related to the position of the input apparatus 3, and output the parameter related to the orientation to the information processing apparatus 2. For example, the calculation of the parameter related to the orientation of the input apparatus 3 may be performed based on the result of detection by an inertial sensor such as an angular velocity sensor 35 or an acceleration sensor 36 described below, or based on the result of detection of reflected light by one or more mouse sensors 34. It should be noted that the calculation of the parameter related to the orientation may also be performed in the input apparatus 3 or in the information processing apparatus 2 if the information processing apparatus 2 receives information about the result of the detection by the inertial sensor or the result of the detection of the reflected light from the input apparatus 3.

In addition, in the case in which the calculation of parameters related to the movement of the input apparatus 3 (parameters related to the movement direction, movement distance, position, orientation, and the like of the input apparatus 3) is performed in the information processing apparatus 2, these parameters may be calculated by execution of a game application as a portion of a game process described below, or a process different from a process using the game application.

The input apparatus 3 includes at least one operation button. For example, the input apparatus 3 shown in FIG. 2 includes two operation buttons 31 and 32 on a top surface thereof. The operation buttons 31 and 32 are arranged at a front portion of the top surface, side by side in the left-right direction, and are configured to be able to be pressed in the direction from the top surface to the bottom surface. The operation buttons 31 and 32 may have a press surface extending from the top surface to the front surface and/or the side surface of the input apparatus 3. The press surfaces of the operation buttons 31 and 32 may not be formed at the top surface and may be formed at the front surface and/or the side surface. The operation buttons 31 and 32 output operation data to the control unit 21 according to the pressing operation.

The input apparatus 3 includes an angular velocity sensor 35 and an acceleration sensor 36 in addition to the operation buttons 31 and 32 and the mouse sensor 34. The input apparatus 3 may include only one of the angular velocity sensor 35 and the acceleration sensor 36.

The angular velocity sensor 35 and the acceleration sensor 36 are inertial sensors that detect the orientation or motion of the input apparatus 3. For example, the angular velocity sensor 35 detects angular velocities around three axes orthogonal to each other of the input apparatus 3. It should be noted that the angular velocity sensor 35 may detect an angular velocity around a single axis or angular velocities around two axes. The acceleration sensor 36 detects accelerations along the three axes. It should be noted that the acceleration sensor 36 may detect an acceleration along a single axis or accelerations along two axes. In addition, the angular velocity sensor 35 and the acceleration sensor 36 are connected to the control unit 21. The result of detection by the angular velocity sensor 35 and/or the acceleration sensor 36 is output to the control unit 21. The control unit 21 is capable of calculating information about the motion and/or orientation of the input apparatus 3 based on the results of detection by the angular velocity sensor 35 and/or the acceleration sensor 36, and as an example, is capable of calculating the rotation (orientation) of the input apparatus 3 in the real space and the orientation or the like of the input apparatus 3 with reference to the gravitational direction.

It should be noted that the input apparatus 3 may be any input apparatus that is configured to be able to be operated by the user. For example, the input apparatus 3 may be in the form of a game controller that is lifted and held by one or both hands of the user. The input apparatus 3 may be removably attached to the information processing apparatus 2 or the display apparatus 4. The input apparatus 3 may be integrated with the information processing apparatus 2 or the display apparatus 4. In addition to or instead of the operation buttons 31 and 32, the input apparatus 3 may be provided with other input means such as other operation buttons, a stick, and a touch panel. In the case in which the input apparatus 3 is integrated and constructed in a predetermined embodiment, the input apparatus 3 may be constructed such that the surface of the input apparatus 3 on which the mouse sensor 34 is provided faces a corresponding member and is not exposed. It should be noted that the input apparatus 3 may be configured to be able to switch the mouse function on/off.

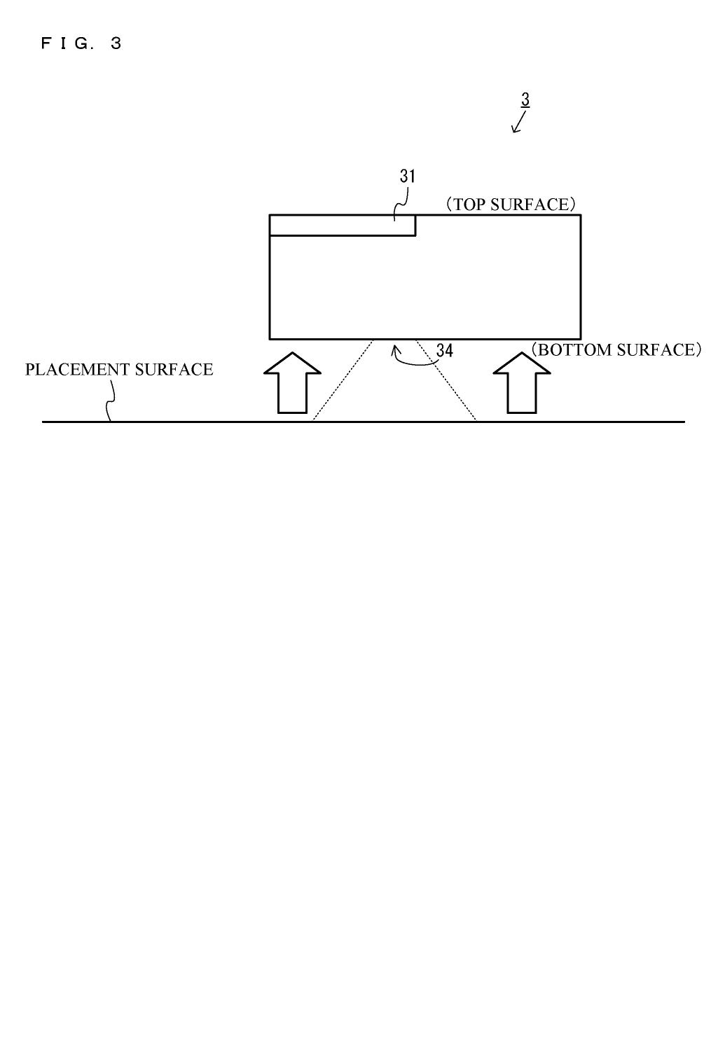

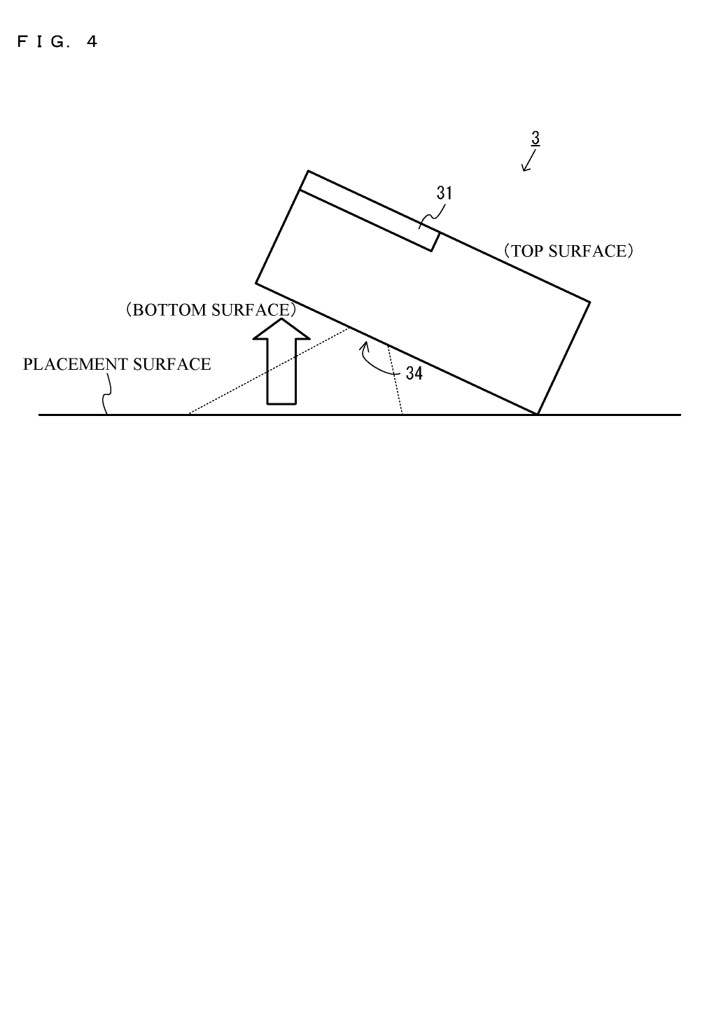

As shown in FIGS. 3 and 4, in the present example, a process based on an operation of lifting the input apparatus 3 from the placement surface can also be executed. As shown in FIG. 3, when the user performs the operation of lifting the input apparatus 3 so that the bottom surface of the input apparatus 3 floats above the placement surface, then if the distance between the bottom surface and the placement surface is greater than or equal to the distance at which the mouse sensor 34 starts to fail to detect reflected light (lift-off distance), the output of the mouse sensor 34 that indicates detection of sufficient reflected light can no longer be obtained. Therefore, by detecting such output of the mouse sensor 34, it can be determined whether the operation of lifting the input apparatus 3 has been performed. The determination may be performed in the input apparatus 3, or in the information processing apparatus 2 if the information processing apparatus 2 receives, from the input apparatus 3, information about the result of the detection of the reflected light. In addition, in the case in which the determination is performed in the information processing apparatus 2, the determination may be performed as a portion of a game process described below by execution of a game application, or performed by a process different from a process using the game application.

It should be noted that the operation of lifting the input apparatus 3 may include not only a state in which the bottom surface of the input apparatus 3 is completely away from the placement surface, but also a state in which a portion of the bottom surface is in contact with the placement surface. For example, as shown in FIG. 4, a state in which the bottom surface of the input apparatus 3 is tilted with respect to the placement surface, so that the distance between the through hole of the bottom surface, in which the mouse sensor 34 is provided, and the placement surface is greater than or equal to the lift-off distance, is the state in which a portion of the bottom surface is in contact with the placement surface. In this case, it may be determined that the operation of lifting the input apparatus 3 has been performed as in the state in which the entire bottom surface is away from the placement surface as shown in FIG. 3. In addition, when it is determined that the operation of lifting the input apparatus 3 has been performed in the state in which a portion of the bottom surface of the input apparatus 3 is in contact with the placement surface, the state in which the entire bottom surface is away from the placement surface and the state in which a portion of the bottom surface is in contact with the placement surface may be distinguished from each other, and different processes may be executed, corresponding to the respective states.

The operation of lifting the input apparatus 3 may be detected by other methods. As an example, it may be determined whether the lift operation has been performed, using the motion or orientation of the input apparatus 3 that is calculated based on the result of detection by an inertial sensor such as the angular velocity sensor 35 or the acceleration sensor 36. As another example, in the case in which the input apparatus 3 is provided with a distance measurement sensor capable of detecting the distance between the bottom surface of the input apparatus 3 and the placement surface, it may be determined whether the lift operation has been performed, using the distance calculated based on the result of detection by the distance measurement sensor.

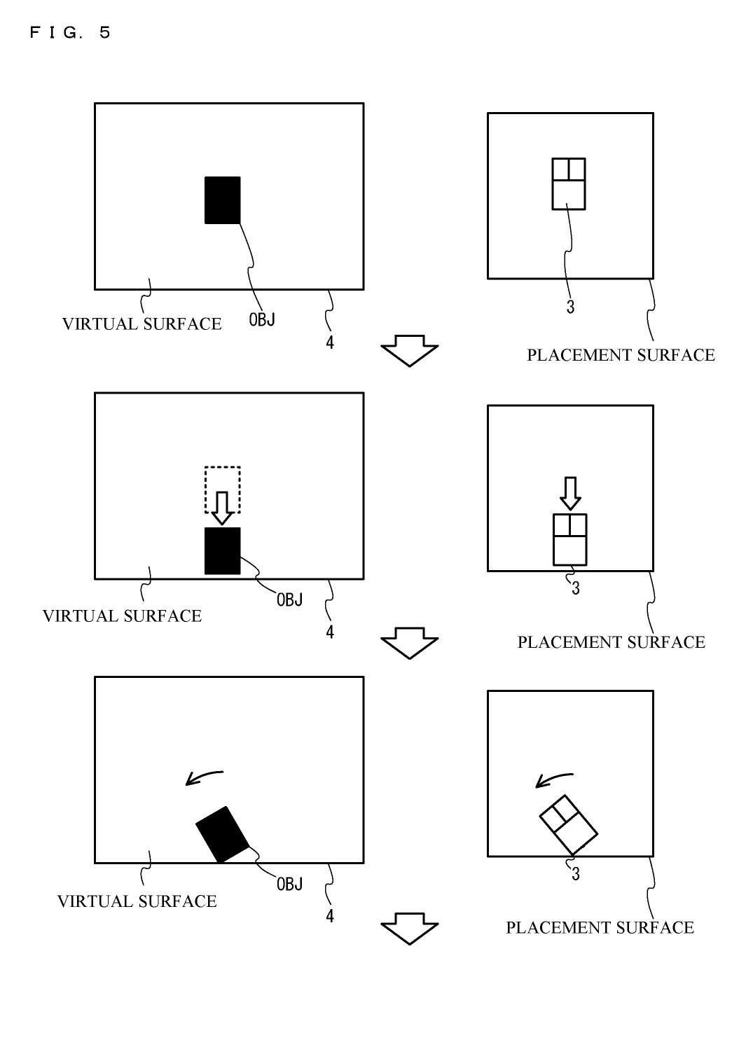

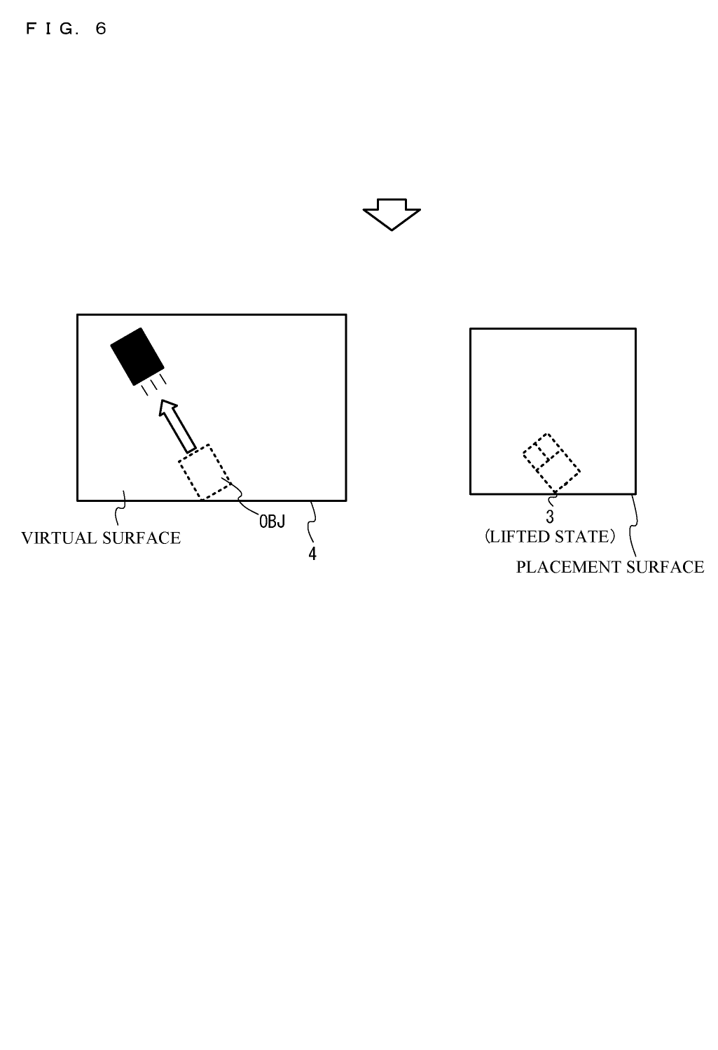

Next, an example of a first game process that is executed in the information processing system 1 will be outlined with reference to FIGS. 5 and 6. Although in the following description, a game is used as an example of an application that is executed in the information processing apparatus 2, other applications may be executed in the information processing apparatus 2.

In FIG. 5, in the first example game process of the present example, an object OBJ displayed on the display apparatus 4 is moved according to an operation input performed on the input apparatus 3. For example, in the first example game process, a process of moving the object OBJ along a virtual surface in a virtual space in a direction corresponding to the orientation of the input apparatus 3 is executed based on the operation of moving the input apparatus 3 on the placement surface or the operation of lifting the input apparatus 3 from the placement surface.

For example, in the upper diagram of FIG. 5, a game image in which an object OBJ disposed at rest on a virtual surface extending in a horizontal direction in a virtual space is viewed in the vertical direction of the virtual space, is displayed on the display apparatus 4. The input apparatus 3 is placed at rest on the placement surface with the bottom surface thereof facing the placement surface. At this time, the distance between the bottom surface of the input apparatus 3 and the placement surface is shorter than the distance at which the mouse sensor 34 starts to fail to appropriately detect the reflected light, so that sufficient reflected light can be detected. Therefore, operation data indicating that the mouse sensor 34 has detected the reflected light is output from the input apparatus 3 to the information processing apparatus 2.

In the middle diagram of FIG. 5, when an operation of moving the input apparatus 3 backward on the placement surface from the rest state (movement operation in the direction indicated by the open arrow in the figure) is performed, operation data corresponding to the movement is output from the input apparatus 3 (e.g., the mouse sensor 34) to the information processing apparatus 2. Here, the backward movement of the input apparatus 3 means that the input apparatus 3 is moved along the placement surface toward the back of the input apparatus 3 opposite to the front of the input apparatus 3 at which the operation buttons 31 and 32 are provided. For example, a parameter related to the movement (e.g., a movement distance over which the input apparatus 3 has been moved backward on the placement surface) is calculated based on the result of the detection of the reflected light by the mouse sensor 34 according to the operation of moving the input apparatus 3 on the placement surface. The object OBJ is moved backward along the virtual surface according to an operation input of moving the input apparatus 3 backward on the placement surface. For example, when the object OBJ is disposed at rest on the virtual surface with the front thereof facing upward in the display screen, then if the input apparatus 3 is moved in a movement direction and over a movement distance (e.g., a backward movement distance), the object OBJ is moved along the virtual surface downward in the display screen by a length corresponding to the movement distance (backward movement in the direction indicated by the open arrow in the figure) and displayed. It should be noted that the object OBJ may be moved directly backward irrespective of the movement direction of the input apparatus 3 on the placement surface. For example, even when the input apparatus 3 is moved in a direction slightly diagonal with respect to the directly backward direction, the object OBJ may be moved directly backward according to the movement distance or a distance corresponding to the component in the directly backward direction of the movement distance.

As shown in the lower diagram of FIG. 5, when after the operation of moving the input apparatus 3 backward on the placement surface, an operation of changing the orientation of the input apparatus 3 on the placement surface is performed (operation of changing the orientation of the input apparatus to the direction indicated by the arrow in the figure), operation data corresponding to a change in the orientation is output from the input apparatus 3 (e.g., the angular velocity sensor 35) to the information processing apparatus 2. For example, the angular velocity sensor 35 detects an angular velocity produced around the axis perpendicular to the placement surface (around the top-bottom direction of the input apparatus 3) according to the operation of changing the orientation of the input apparatus 3, and based on the result of the detection, a change in the orientation of the input apparatus 3 is calculated. In addition, the orientation of the object OBJ is changed on the virtual surface according to the operation input for changing the orientation of the input apparatus 3 on the placement surface (the change of the orientation of the object OBJ to the direction indicated by the arrow in the figure is displayed). For example, the displayed orientation of the object OBJ on the virtual surface is changed so as to rotate in the same direction and change amount as those of the changed orientation of the input apparatus 3. As an example, when the operation of changing the orientation of the input apparatus 3 to the left by 30° on the placement surface is performed, the object OBJ is rotated around the barycenter thereof to the left by 30° and displayed on the virtual surface.

Referring to FIG. 6, when the operation of lifting the input apparatus 3 from the placement surface is performed (indicated by the dashed line in FIG. 6) after the operation of moving the input apparatus 3 backward on the placement surface, operation data indicating that sufficient reflected light is not detected by the mouse sensor 34 is output from the input apparatus 3 (e.g., the mouse sensor 34) to the information processing apparatus 2. As described above, when an operation is performed such that the distance between the bottom surface of the input apparatus 3 and the placement surface is greater than or equal to the distance at which the mouse sensor 34 starts to fail to appropriately detect the reflected light, an output indicating that sufficient reflected light is detected by the mouse sensor 34 is no longer obtained, and by detecting that the output is no longer obtained, it is determined that the operation of lifting the input apparatus 3 has been performed. When it is determined that the operation of lifting the input apparatus 3 from the placement surface has been performed, the object OBJ is moved forward along the virtual surface (forward movement in the direction indicated by the open arrow in the figure is displayed). For example, the object OBJ is moved forward on the virtual surface based on the orientation in which the object OBJ is displayed at the time when the lift operation is performed. Therefore, the operation of changing the orientation of the input apparatus 3 also serves as an operation for changing the direction in which the object OBJ is moved forward along the virtual surface. It should be noted that the movement speed and movement amount at and in which the object OBJ is moved forward may have a predetermined value, or may be set based on the amount of movement energy accumulated due to the backward movement. In the latter case, the movement speed and movement amount of the forward movement of the object OBJ may be set such that as the amount of accumulated movement energy increases, the movement speed of the forward movement increases and/or the maximum distance over which the forward movement is allowed increases.

Thus, in the first example game process, the movement direction of the forward movement of the object OBJ corresponds to the orientation that the input apparatus 3 has at the time when the input apparatus 3 is lifted from the placement surface. Thus, when the operation of lifting the mouse is performed, a novel operation including an operation in which the orientation of the input apparatus 3 is used in the operation of lifting the input apparatus 3 can be carried out compared to a typical operation of maintaining the position of an object operated using the mouse.

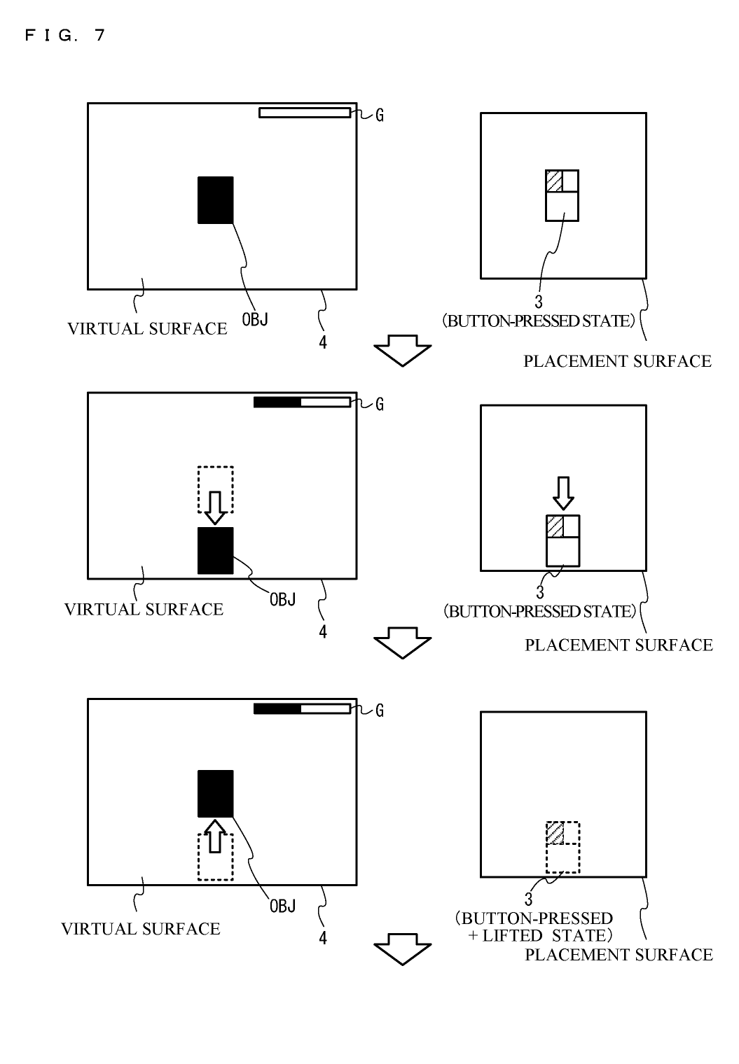

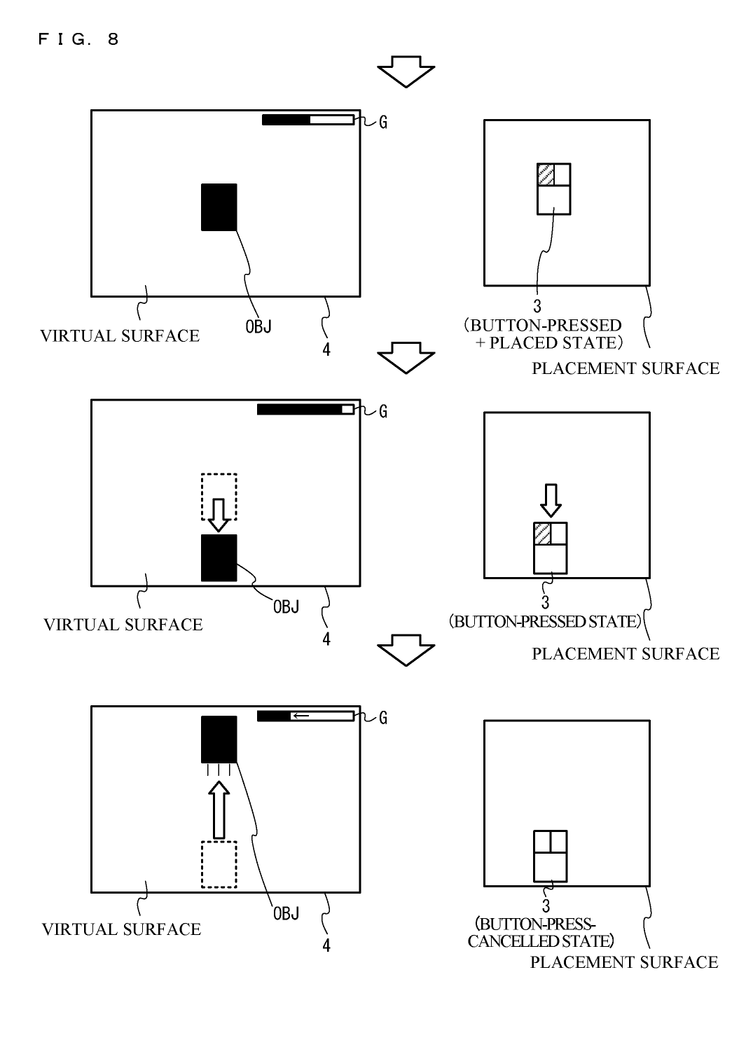

Next, a second example game process that is executed in the information processing system 1 will be outlined with reference to FIGS. 7 and 8.

In FIG. 7, in the second example game process of the present example, an object OBJ displayed on the display apparatus 4 is also moved according to an operation input performed on the input apparatus 3. For example, in the second example game process, executed is a process of moving the object OBJ along a virtual surface in a virtual space based on the operation of moving the input apparatus 3 on the placement surface, the operation of lifting the input apparatus 3 from placement surface, and the operation of pressing one (e.g., the operation button 31) of the operation buttons of the input apparatus 3.

For example, in the upper diagram of FIG. 7, the display apparatus 4 displays a gauge G indicating the amount of movement energy accumulated in the object OBJ. The operation button 31 of the input apparatus 3 is kept pressed.

In the middle diagram of FIG. 7, when the operation of moving the input apparatus 3 backward on the placement surface with the operation button 31 pressed (movement operation in the direction indicated by the open arrow in the figure) is performed, the object OBJ is moved backward along the virtual surface. In the second example game process, movement energy for subsequently moving the object OBJ forward is accumulated according to the length over which the object OBJ has been moved backward on the virtual surface. The amount of movement energy currently accumulated is indicated by the gauge G.

As shown in the lower diagram of FIG. 7, when after the operation of moving the input apparatus 3 backward on the placement surface, the operation of lifting the input apparatus 3 from the placement surface is performed with the operation button 31 pressed (indicated with the dashed line in the lower diagram of FIG. 7), operation data corresponding to the lift operation is output from the input apparatus 3 (e.g., the mouse sensor 34) to the information processing apparatus 2. When it is determined that the operation of lifting the input apparatus 3 from the placement surface has been performed, the object OBJ is moved along the virtual surface back to the initial position (movement in the direction indicated by the open arrow in the figure is displayed). The initial position may be the position immediately before the backward movement, or a predetermined position (e.g., the center of the display screen). It should be noted that movement energy is not consumed or accumulated due to the movement back to the initial position, and therefore, the amount of movement energy indicated by the gauge G is maintained at the level immediately before the lift operation. The user can feel like maintaining movement energy by continuing to press the operation button 31.

Referring to the upper diagram of FIG. 8, the input apparatus 3, which has been lifted from the placement surface, is placed back to the placement surface at any position and is thus in contact with the placement surface (indicated with the solid line in the upper diagram of FIG. 8). The position to which the input apparatus 3 is returned may be different from the position where the input apparatus 3 is initially placed as shown in the upper diagram of FIG. 7.

In the middle diagram of FIG. 8, when an operation of moving the input apparatus 3 backward on the placement surface again from the state in which the input apparatus 3 has been returned to the placement surface with the operation button 31 pressed (movement operation in the direction indicated by the open arrow in the figure) is performed, the object OBJ is moved backward along the virtual surface again. In the second example game process, the movement energy is further accumulated according to the length over the object OBJ has been moved backward on the virtual surface again, and the amount of movement energy added and accumulated due to the backward movement performed again is indicated by the gauge G. Thus, the amount of accumulated movement energy of the object OBJ can be further increased by repeatedly performing the operation of moving the object OBJ backward.

In the lower diagram of FIG. 8, when after the operation of moving the input apparatus 3 backward on the placement surface is repeatedly performed, an operation of cancelling the pressing of the operation button 31 is performed, operation data corresponding to the cancellation of the pressing operation is output from the input apparatus 3 to the information processing apparatus 2. It should be noted that the input apparatus 3 is placed on the placement surface, and is not lifted. When the operation of cancelling the pressing of the operation button 31 is performed, the object OBJ is moved forward along the virtual surface (forward movement in the direction indicated by the open arrow in the figure is displayed). The movement speed and movement amount at and in which the object OBJ is moved forward are set based on the amount of movement energy accumulated due to the repeated backward movement. It should be noted that in the second example game process, the orientation of the object OBJ on the virtual surface may also be changed according to the operation of changing the orientation of the input apparatus 3 on the placement surface.

Thus, in the second example game process, by performing the operation of lifting the input apparatus 3 from the placement surface, the object OBJ can be returned to the initial position on the virtual surface. Therefore, the operation of lifting the input apparatus 3 from the placement surface is suitable for the case in which the movement of the object OBJ from the initial position is repeatedly performed.

It should be noted that the virtual surface in the first and second example game process may be a flat surface or curved surface. In addition, the virtual surface may be a field, a water surface, or an invisible surface defined in the air. In addition, the object OBJ may be any object, including a vehicle such as a car, ship, or aircraft, a bow and arrow or a bullet, or a spherical or cylindrical object. For example, in the first example game process, in the case in which the object OBJ is a bow and arrow, a game can be carried out in which the bow is drawn along the defined surface according to the operation of moving the input apparatus 3 backward, and the direction in which the arrow is to be shot (the direction in which the bow is drawn) is changed by moving the defined surface according to the operation of changing the orientation of the input apparatus 3, so that the arrow is shot along the defined surface according to the operation of lifting the input apparatus 3.

In addition, in the first and second example game processes, by the operation of changing the orientation of the input apparatus 3 on the placement surface before moving the object OBJ forward, the orientation of the object OBJ on the virtual surface is changed so that the direction of the forward movement is determined. In another example, the direction opposite to the direction in which the object OBJ is moved in order to accumulate movement energy (in the first example game process, the direction in which the object OBJ is moved by moving the input apparatus 3 along the placement surface, and in the second example game process, the direction in which the object OBJ is moved by moving the input apparatus 3 along the placement surface with the operation button 31 pressed) may be determined as a direction in which the object OBJ is to be moved, consuming the movement energy. In that case, the direction in which the object OBJ is moved in order to accumulate movement energy may not be the direction in which the object OBJ is moved backward, and may be any direction with respect to the object OBJ. Thus, the direction of the operation of moving the input apparatus 3 along the placement surface in order to accumulate movement energy may not be the direction in which the input apparatus 3 is moved backward, and may be the direction of the operation of moving the input apparatus 3 along the placement surface in any direction.

In addition, the input apparatus 3 may be provided with a vibrator that vibrates the input apparatus 3 according to control of the information processing apparatus 2 and/or a loudspeaker that outputs sounds from the input apparatus 3. In that case, as an example, in the first and second example game processes, vibrations and/or sounds may be produced from the input apparatus 3 while the object OBJ is being moved in order to accumulate movement energy.

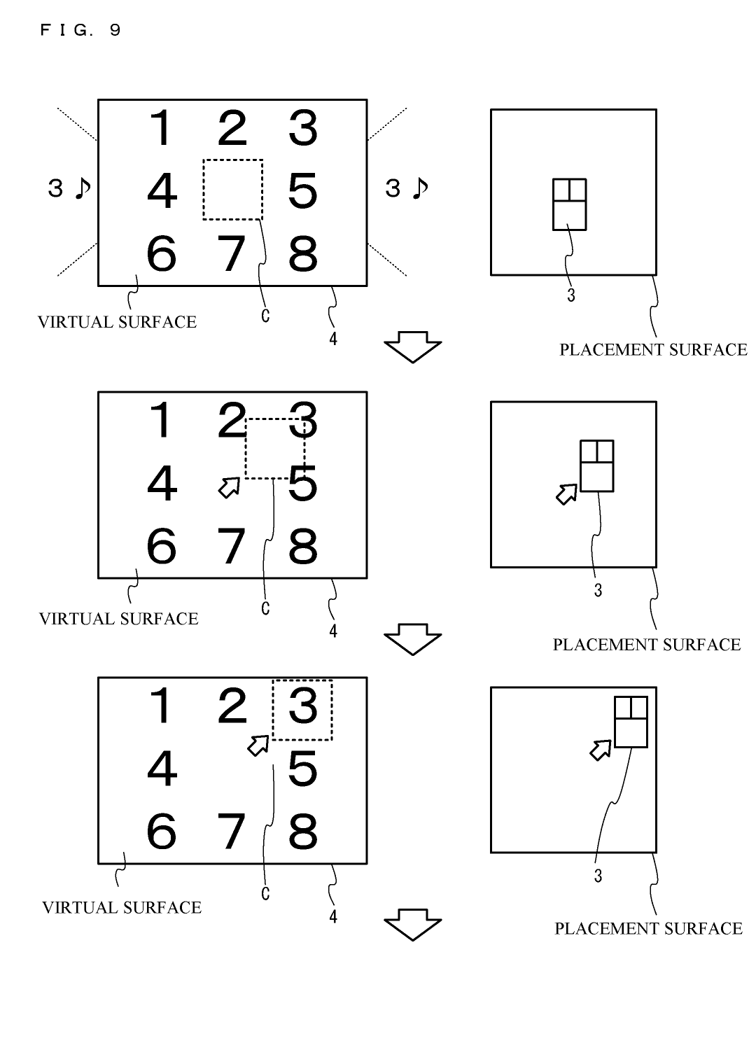

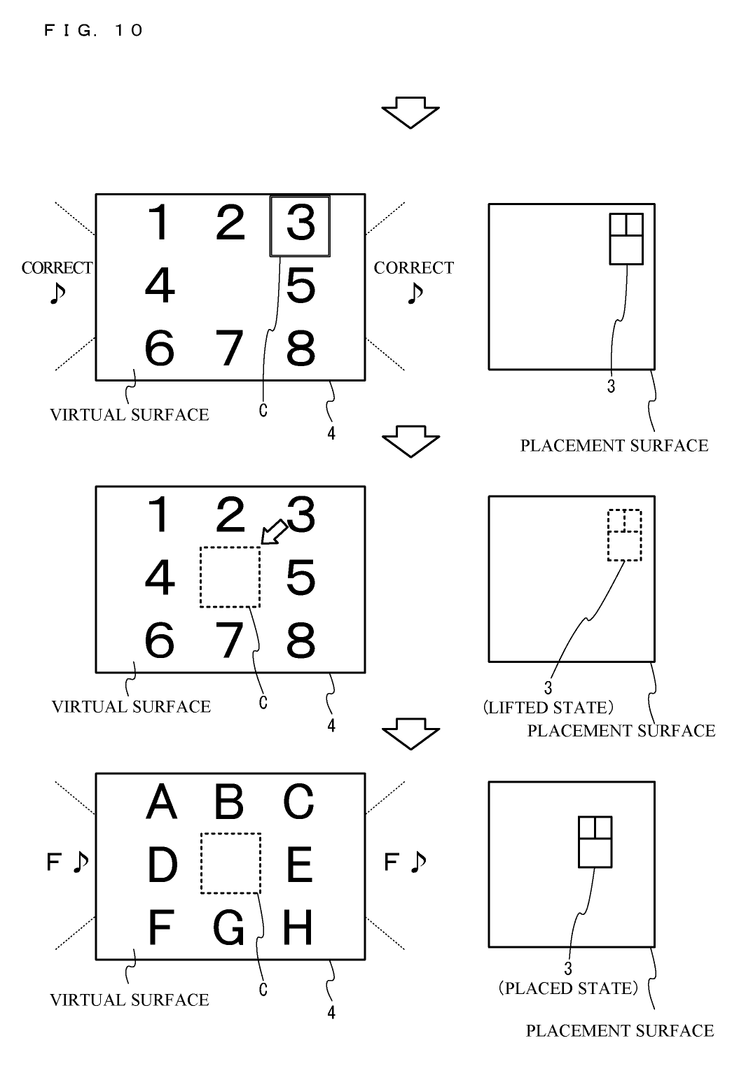

Next, a third example game process that is executed in the information processing system 1 will be outlined with reference to FIGS. 9 and 10. The third example game process is a game in which a cursor C is moved to a designated option.

In FIG. 9, in the third example game process of the present example, the cursor C displayed on the display apparatus 4 is moved according to an operation input performed on the input apparatus 3.

For example, in FIGS. 9 and 10, the display apparatus 4 displays a plurality of different numerical figures(specifically, the numerical FIGS. 1 to 8) as options in a region excluding a central region of the display screen. In the upper diagram of FIG. 9, the cursor C is disposed at rest in the central region on a virtual surface. In the state in which the plurality of numerical figures are displayed, one of the numerical figures that the user is caused to select is designated, and the designated numerical figure is presented as a question to the user using sound or an image. In the example shown in the upper diagram of FIG. 9, the numerical FIG. 3 is designated from the plurality of numerical figures.

In the middle diagram of FIG. 9, when the operation of moving the input apparatus 3 on the placement surface (movement operation in the direction indicated by the open arrow in the figure) is performed, the cursor C is moved along the virtual surface. The user performs an operation of moving the cursor C so as to select the designated numerical figure as soon as possible.

In the lower diagram of FIG. 9, the numerical FIGURE“3” has been selected from the plurality of numerical figures by the user operating the input apparatus 3 to move the cursor C. It should be noted that it may be necessary for the user to perform a predetermined operation such as pressing the operation button 31 on the input apparatus 3 in order to confirm the selected option.

Referring to the upper diagram of FIG. 10, in the information processing system 1, it is determined whether the designated numerical figure matches the numerical figure selected by the user, and how long it has taken the user to select the numerical figure, and the user’s score or the like is changed.

As shown in the middle diagram of FIG. 10, the result of the question is reported, and thereafter, when the operation of lifting the input apparatus 3 from the placement surface is performed (indicated with the dashed line in the middle diagram of FIG. 10), the cursor C is moved back to the initial position (e.g., the center region) along the virtual surface (movement in the direction indicated by the open arrow in the figure is displayed). It should be noted that the cursor C may be returned to a predetermined region (e.g., the center region) including at least the initial position instead of being exactly returned to the initial position set during the start of a game.

Referring to the lower diagram of FIG. 10, the input apparatus 3, which has been lifted from the placement surface, is placed back to the placement surface at any position and is thus in contact with the placement surface (indicated with the solid line in the lower diagram of FIG. 10). For the next question, a process of repeating the procedure described with reference to the middle diagram of FIG. 9 to the middle diagram of FIG. 10 is executed.

Thus, in the third example game process, when a plurality of questions are asked, the operation of lifting the input apparatus 3 from the placement surface in order to address the next question is performed, whereby the cursor C is more easily returned to the initial position for preparation. Therefore, the preparation can be quickly performed. In addition, the cursor C can be returned to the previously determined initial position irrespective of the position to which the input apparatus 3 is returned on the placement surface. Therefore, the present example is particularly suitable for the case in which an operation from the initial position is repeatedly performed.

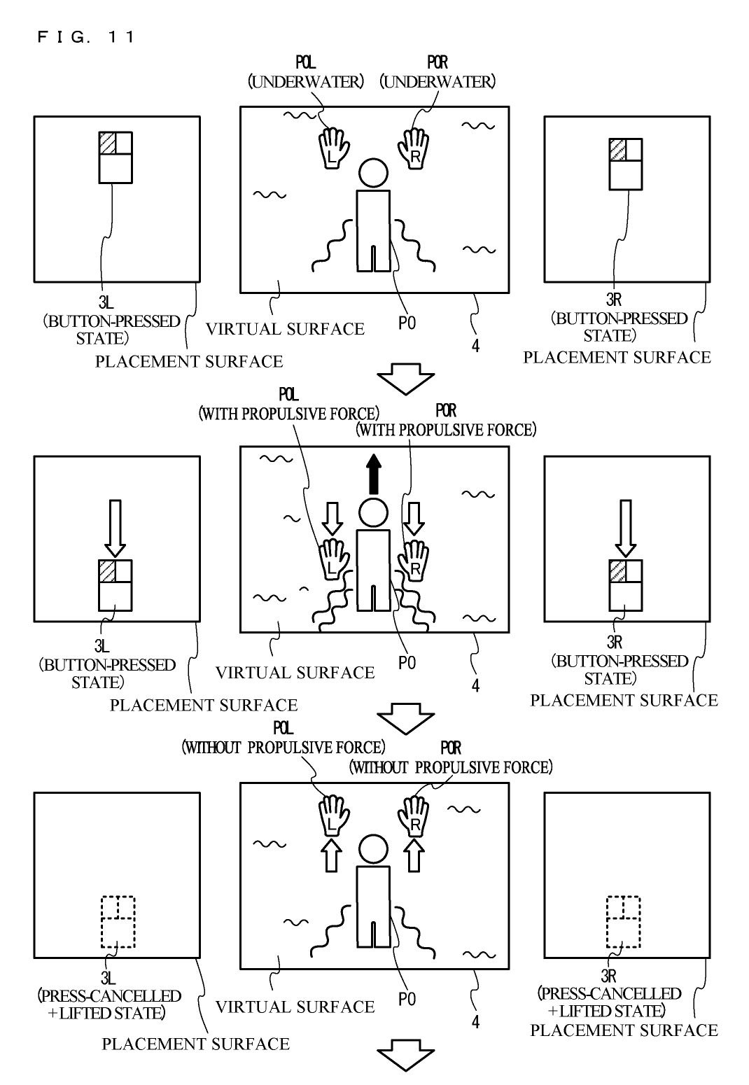

Next, a fourth example game process that is executed in the information processing system 1 will be outlined with reference to FIGS. 11 to 16.

In FIGS. 11 to 13, in the fourth example game process of the present example, two input apparatuses 3L and 3R are used. The input apparatuses 3L and 3R may be the same or different. As an example, the input apparatus 3L may be shaped so as to be easy to operate with the left hand, and the input apparatus 3R may be shaped so as to be easy to operate with the right hand. The input apparatuses 3L and 3R are each connected to the information processing apparatus 2 wirelessly or by a cable, and output the operation data described above. In the present example, the input apparatus 3L is operated with the user’s left hand, and the input apparatus 3R is operated with the user’s right hand.

In the fourth example game process of the present example, the motion of a left hand POL of a player object PO displayed on the display apparatus 4 is controlled according to an operation input performed on the input apparatus 3L. The motion of a right hand POR of the same player object PO is controlled according to an operation input performed on the input apparatus 3R. In the fourth example game process, an example is used in which the player object PO swims in the swimming style breaststroke.

For example, the display apparatus 4 displays a game image in which the player object PO, which is swimming near a virtual surface that is a water surface extending in the horizontal direction of a virtual space and along the virtual surface, is viewed in the vertical direction of the virtual surface. The player object PO has a head, a body, legs, and the like as well as the left hand POL and the right hand POR. The left hand POL and the right hand POR are objects linked to the body of the player object PO. It should be noted that the left hand POL and the right hand POR, when displayed, are not necessarily actually linked to the body. The left hand POL and the right hand POR may be virtually linked together and may restrict each other in terms of motion and distance. No matter whether the left hand POL and the right hand POR are displayed, being actually linked to or separately from the body of the player object PO, the left hand POL and the right hand POR are a part of a single human body as a whole.

In the upper diagram of FIG. 11, the input apparatuses 3L and 3R are placed at rest on the placement surface with the operation button 31 pressed and the bottom surface thereof facing the placement surface. The left hand POL and the right hand POR are disposed at the respective initial positions in front of the player object PO with reference to the player object PO. In addition, the left hand POL and the right hand POR are displayed, being disposed underwater, because the operation button 31 is pressed. It should be noted that the left hand POL and the right hand POR may be actually disposed underwater in the virtual space or may be simply expressed as being disposed underwater by coloration or the like. In addition, in the foregoing description, for the input apparatuses 3L and 3R, the same operation button 31 is pressed, or alternatively, different operation buttons may be pressed. For example, the operation button 31 may be pressed for the input apparatus 3L, and the operation button 32 may be pressed for the input apparatus 3R.

In the middle diagram of FIG. 11, when an operation of moving the input apparatuses 3L and 3R backward on the placement surface with the operation buttons 31 pressed (movement operation in the direction indicated by the open arrow in the figure) is performed, the left hand POL and the right hand POR of the player object PO are moved underwater along the water surface so as to push water backward from the initial position in the front with reference to the player object PO based on the movement direction and movement distance of the operation (movement in the direction indicated by the open arrow in the figure is displayed). As a result, the player object PO acquires a propulsive force corresponding to the speed and length at and over which the left hand POL and the right hand POR push water, and thereby, can swim on the water surface or underwater in a movement direction based on the direction in which water is pushed. In the example shown in the middle diagram of FIG. 11, almost the same propulsive force is acquired from the left hand POL and the right hand POR, and therefore, the player object PO swims straight forward (movement in the direction indicated by the closed arrow in the figure is displayed). At this time, the left hand POL and the right hand POR are also moved in association with the movement of the player object PO in the virtual space. It should be noted that while the left hand POL and the right hand POR try to move forward as with the player object PO in association with the forward movement of the player object PO, the left hand POL and the right hand POR move backward relative to the player object PO. Therefore, whether the left hand POL and the right hand POR move forward or backward in the virtual space is determined, depending on the amount of the forward movement of the player object PO and the amount of the backward movement of the left hand POL and the right hand POR with respect to the player object PO. However, in a game in which the user desires to move the player object PO forward, the left hand POL and the right hand POR consequently move forward in the virtual space.

It should be noted that in the present example, when the above operation is performed on the input apparatus 3L or 3R with the pressing of the operation button 31 cancelled, the left hand POL or the right hand POR is moved relative to the player object PO without pushing water, so that the propulsive force is not acquired. Therefore, the in-game effect of acquiring the propulsive force by the player object PO moving the left hand POL and the right hand POR in the fourth example game process is produced only when the operation of pressing the operation button 31 is being performed.

As shown in the lower diagram of FIG. 11, when after the operation of moving the input apparatuses 3L and 3R backward on the placement surface, the operation of lifting the input apparatuses 3L and 3R from the placement surface with the pressing of the operation button 31 cancelled is performed (indicated with the dashed line in the lower diagram of FIG. 11), the left hand POL and the right hand POR of the player object PO are moved underwater along the water surface back to the respective predetermined return positions (movement in the direction indicated by the open arrow in the figure is displayed). Here, when the left hand POL and the right hand POR are moved underwater back to the front, a force may be applied in a direction opposite to the direction in which the player object PO is swimming, so that the propulsive force may be reduced or a force may be applied in a direction different from the direction in which the player object PO is swimming, resulting in a change in the swimming direction. However, in the present example, when the input apparatuses 3L and 3R are operated with the pressing of the operation button 31 cancelled, this operation does not produce a propulsive force on the player object PO, so that the left hand POL and the right hand POR can be moved underwater without producing the opposite force or a change in the swimming direction occurring on the player object PO. It should be noted that the return positions of the left hand POL and the right hand POR are described below.

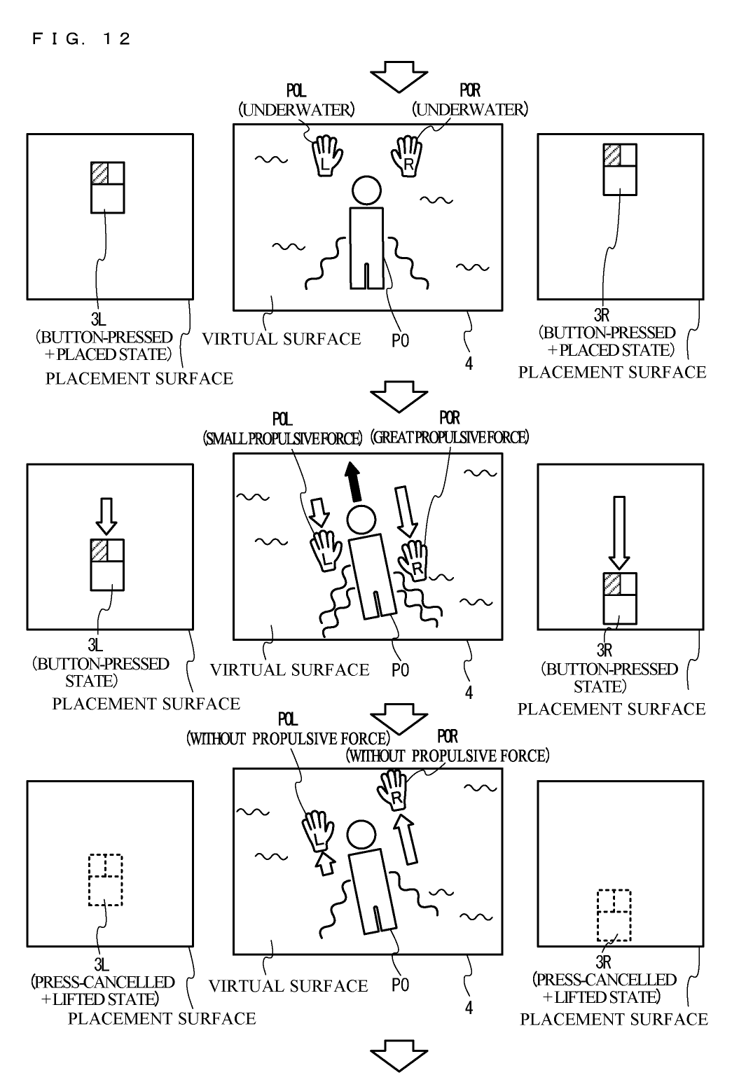

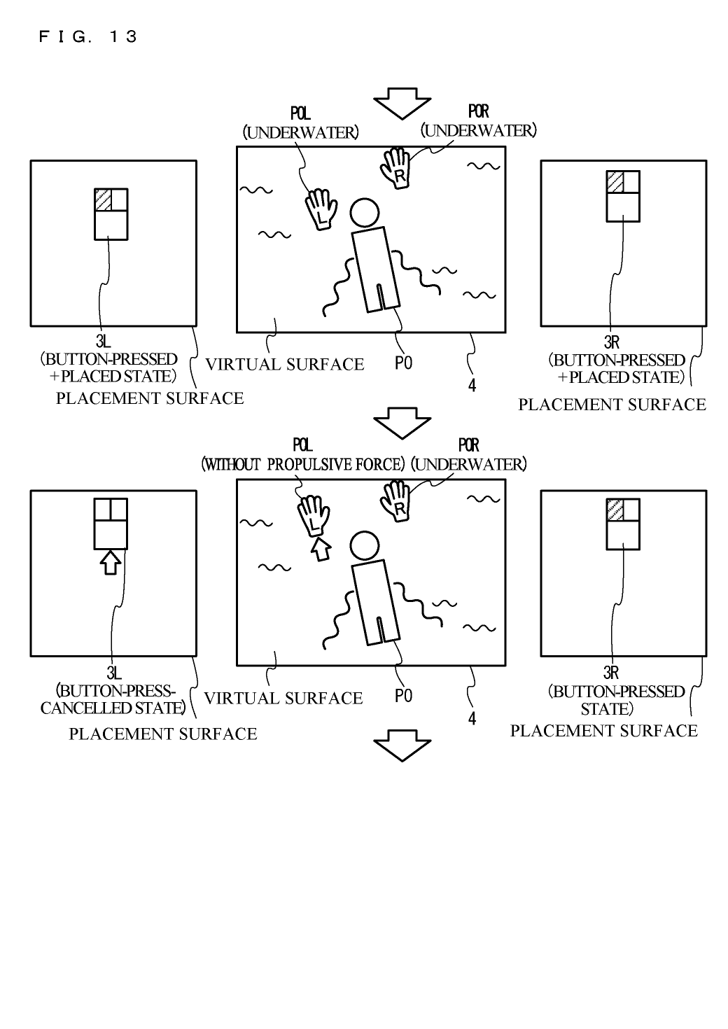

Referring to the upper diagram of FIG. 12, the input apparatuses 3L and 3R, which have been lifted from the placement surface, are returned to the placement surface at any respective positions forward of the positions where the input apparatuses 3L and 3R have been lifted, and are placed in contact with the placement surface (indicated with the solid line in the upper diagram of FIG. 13), and the operation buttons 31 of the input apparatuses 3L and 3R are pressed again.

As shown in the middle diagram of FIG. 12, when an operation of moving the input apparatuses 3L and 3R backward on the placement surface again with the operation button 31 pressed (movement operation in the direction indicated by the open arrow in the figure) is performed, the left hand POL and the right hand POR of the player object PO are moved underwater along the water surface so as to push water backward from the return positions. In the example shown in the middle diagram of FIG. 12, the input apparatus 3R is operated and moved backward on the placement surface over a longer distance than that of the input apparatus 3L, and therefore, the right hand POR pushes a greater amount of water backward. As a result, a greater propulsive force is applied to the player object PO by the right hand POR, and therefore, the direction in which the player object PO is swimming is changed to a forward and slightly leftward direction, and the player object PO moves in the resultant direction (movement in the direction indicated by the closed arrow in the figure is displayed). The position to which the right hand POR is moved backward is backward of the position to which the left hand POL is moved backward with reference to the player object PO.

As shown in the lower diagram of FIG. 12, when the operation of lifting the input apparatuses 3L and 3R from the placement surface with the pressing of the operation button 31 cancelled (indicated with the dashed line in the lower diagram of FIG. 12) is performed, the left hand POL and the right hand POR of the player object PO are moved underwater along the water surface back to respective predetermined return positions (movement in the direction indicated by the open arrow in the figure is displayed).

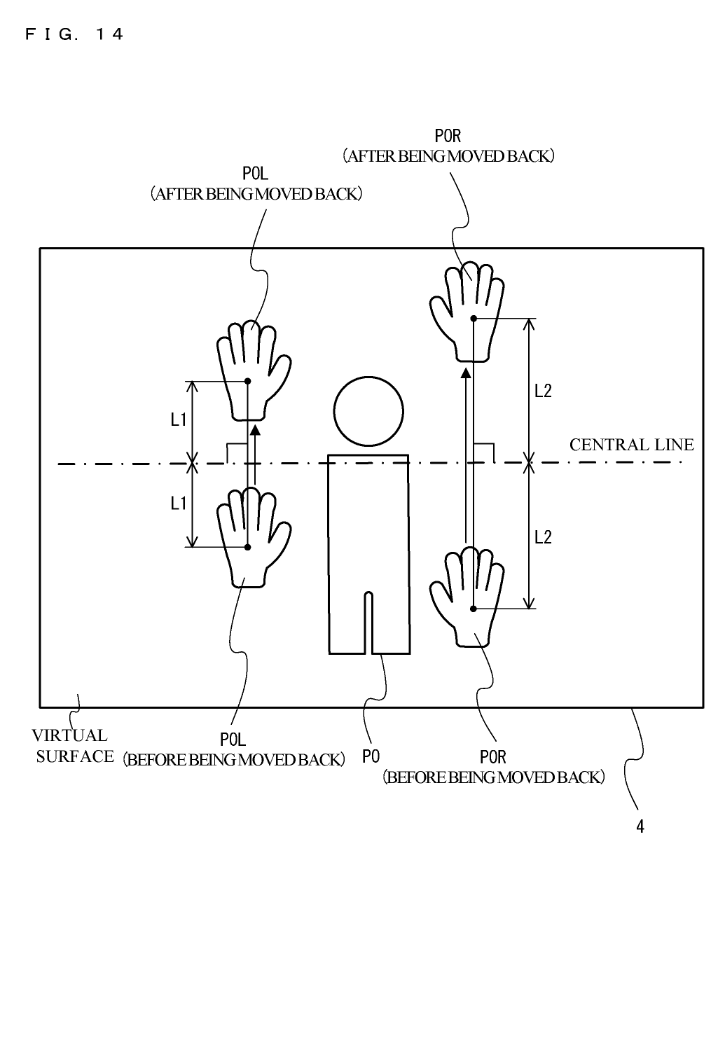

An example of the return positions of the left hand POL and the right hand POR of the player object PO will be described with reference to FIG. 14. The return positions of the left hand POL and the right hand POR are set to positions based on the positions where the left hand POL and the right hand POR are disposed at the time when the input apparatuses 3L and 3R are lifted from the placement surface. For example, a mirror-symmetric position with respect to the player object PO, e.g., a position that is mirror-symmetric to the position displayed at the time when the lift operation is performed with respect to a straight line connecting left and right particular parts (e.g., both shoulders) of the player object PO as a central line, is set as the return position. Specifically, when the position of the left hand POL at the time when the input apparatus 3L is lifted from the placement surface is at a distance L1 backward away from the central line, the position that is at the distance L1 forward away from the central line and that is mirror-symmetric to the lift position with reference to the central line is set as the return position of the left hand POL. In addition, when the position of the right hand POR at the time when the input apparatus 3R is lifted from the placement surface is at a distance L2 backward away from the central line, the position that is at the distance L2 forward away from the central line and that is mirror-symmetric to the lift position with reference to the central line is set as the return position of the right hand POR. It should be noted that when the positions of the left hand POL and the right hand POR at the time when the input apparatuses 3L and 3R are lifted from the placement surface are positioned in front of the central line, then even if the operation of lifting the input apparatuses 3L and 3R is performed, the positions of the left hand POL and the right hand POR may be maintained without the left hand POL and the right hand POR being moved back to the front. In addition, the return positions may be limited within a predetermined range (e.g., the respective ranges within which the left hand POL and the right hand POR of the player object PO can reach). Thus, the return positions of the left hand POL and the right hand POR are involved with the operation of moving the input apparatuses 3L and 3R backward, and therefore, novel operation experience can be achieved in general operations of the player object PO.

Referring back to the upper diagram of FIG. 13, the input apparatuses 3L and 3R, which have been lifted from the placement surface, are each returned to the placement surface at any position in front of the lift position, and disposed in contact with the placement surface (indicated with the solid line in the upper diagram of FIG. 13), and the operation buttons 31 of the input apparatuses 3L and 3R are pressed again. By this operation, the left hand POL and the right hand POR are disposed underwater at the respective return positions, and because the length over which the right hand POR have pushed water backward is longer than that of the left hand POL, the right hand POR is disposed forward of the left hand POL with respect to the player object PO.

When the user tries to cause the player object PO to swim in the desired direction with the left hand POL and the right hand POR thus arranged, the left hand POL and the right hand POR are not flush laterally, and therefore, it is difficult to determine which of the left hand POL and the right hand POR is to be moved backward to what degree. To solve such a problem, the user performs an operation of moving the input apparatus 3L forward on the placement surface with the operation of pressing the operation button 31 cancelled. By this operation, the left hand POL is moved on the water to the front of the player object PO, and therefore, can be returned to a position where the left hand POL is flush with the right hand POR in front of the player object PO. Because the input apparatus 3L is operated with the operation of pressing the operation button 31 cancelled, a propulsive force that is caused by the forward movement of the left hand POL is not produced on the player object PO.

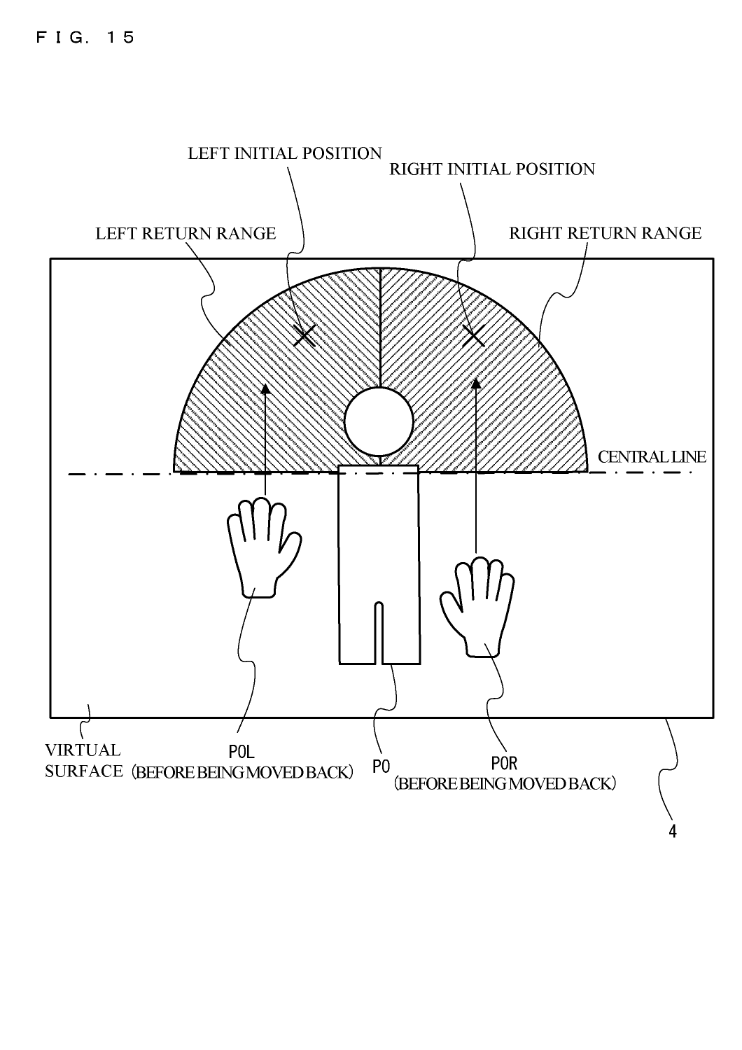

It should be noted that the return positions of the left hand POL and the right hand POR may be set to other positions. As an example, as shown in FIG. 15, the return positions of the left hand POL and the right hand POR may be set to positions (e.g., random positions) within a predetermined range. Specifically, a left return range to which the left hand POL is returned is a range that is positioned forward of the central line and leftward of the player object PO, and includes a left initial position that is positioned before the left hand POL is moved, pushing water backward, according to the operation of moving the input apparatus 3L backward along the placement surface. A right return range to which the right hand POR is returned is similarly set. Thus, in the above example of the return positions, the left hand POL and the right hand POR are returned to any positions within the ranges set on the left and right sides, and therefore, amusingness can be improved compared to the case in which the left hand POL and the right hand POR are returned to the same positions.

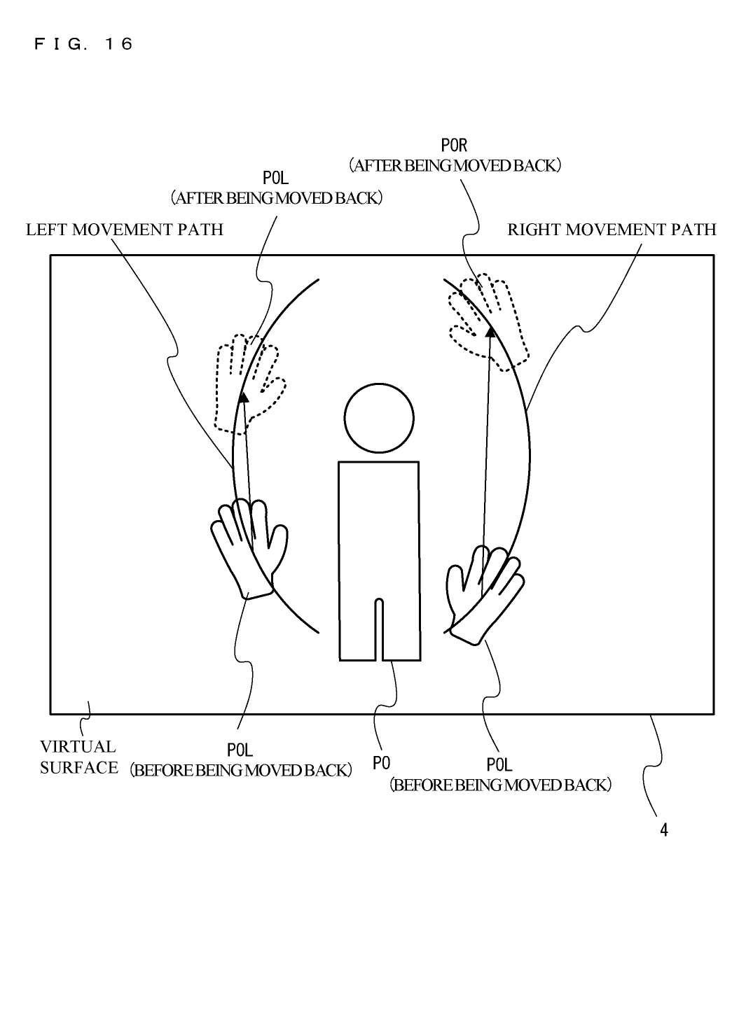

As another example, as shown in FIG. 16, the return positions of the left hand POL and the right hand POR may be set to positions on paths along which the left hand POL and the right hand POR are moved backward according to the operation of moving the input apparatuses 3L and 3R backward (e.g., a path along which water is pushed backward). In this example, the left hand POL and the right hand POR are moved backward on predetermined paths no matter what paths the input apparatuses 3L and 3R are moved backward along. The return position of the left hand POL is set on the path. As an example, the return position of the left hand POL is set to a position that is at a predetermined distance forward away from the position thereof at the time when the operation of lifting the input apparatus 3L is performed, on a left movement path along which the left hand POL is moved, pushing water backward, before the lift operation. The return position of the right hand POR is similarly set. It should be noted that the longer the distance of the display position at the time when the lift operation is performed (e.g., the position where the pushing water backward ends), the longer the return position may be set. In addition, the return position may be set to a random position on the movement path.

In addition, the return positions of the left hand POL and the right hand POR may be the positions where the left hand POL and the right hand POR are displayed immediately before the operation of moving the input apparatuses 3L and 3R backward (e.g., the positions immediately before water is pushed backward). In this case, the left hand POL and the right hand POR are necessarily repeatedly returned to the same initial positions, and therefore, are suitable for the process of controlling the motion of pushing water from the initial positions. Therefore, the difficulty in the operation can be reduced compared to other return positions.

As described above with reference to FIGS. 11 to 13, by repeatedly performing the lift operation after simultaneously moving the input apparatuses 3L and 3R backward on the placement surface, the player object PO can be caused to repeatedly perform an action of pushing water with the left hand POL and the right hand POR simultaneously to move forward. For example, a scene may be assumed in which the player object PO is moved in a swimming style in which the player object PO swims by performing an action of pushing water by moving the left hand POL and the right hand POR simultaneously, such as breaststroke and butterfly. It should be noted that for some swimming styles performed by the player object PO, the operation of moving the input apparatuses 3L backward on the placement surface and lifting the input apparatuses 3L and the operation of moving the input apparatuses 3R backward on the placement surface and lifting the input apparatuses 3R may be alternately performed. For example, a scene may be assumed that the player object PO is moved in a swimming style in which the player object PO swims by repeatedly performing an action of pushing water by alternately using the left hand POL and the right hand POR, such as crawl and backstroke. In addition, other parts (e.g., legs) of the player object PO may be caused to perform an action based on the selected swimming style in association with the motions of the left hand POL and the right hand POR.

It should be noted that in the first to fourth example game processes, the virtual surface along which an object is moved may be a flat surface that is not horizontal in the virtual space (e.g., a vertical surface or a sloped surface). In addition, the virtual surface may not be a flat surface, and may be a curved surface or an uneven surface. Furthermore, the position and/or shape of the virtual surface may be changed over time.

In addition, in the present example, an object that is moved along a virtual surface directly according to an operation of moving an input apparatus is not limited to an object that is entirely moved as in the first to third example game processes. As in the fourth example game process, only a portion of an object may be moved. For example, the movement of an object may include movement performed when the shape or orientation of the object is changed. Movement performed when the shape of an arm or leg is changed or movement performed when the position of an arm or leg is changed may be along the virtual surface.

In addition, the movement of an object along a virtual surface is not limited to movement that is performed while the object is invariably in contact with the virtual surface, and includes movement that is performed while the object is separated from the virtual surface. For example, in the second example game process, when the object OBJ is moved on a virtual surface (e.g., a field in the virtual space) according to the operation of moving the input apparatus 3 on the placement surface, and is moved back to another position on the virtual surface with the object OBJ slightly floating above the virtual surface according to the operation of lifting the input apparatus 3, these movement forms of the object OBJ are all included in movement along the virtual surface. In addition, in the fourth example game process, movement of the left hand POL and the right hand POR or the player object PO while approaching or leaving a water surface or a virtual surface parallel to a water surface, is included in movement along a virtual surface.

In addition, in the first to fourth example game processes, when the operation of lifting the input apparatus 3 from the placement surface is being performed, then if another operation of using the input apparatus 3 is performed, a game process that does not have an influence on the motion of an object controlled by the input apparatus 3 may be executed. In addition, control may be performed such that a game process corresponding to an operation performed when the input apparatus 3 is disposed on the placement surface (e.g., the operation of pressing the operation buttons 31 and 32) may be different from a game process corresponding to that operation performed when the input apparatus 3 is lifted from the placement surface.

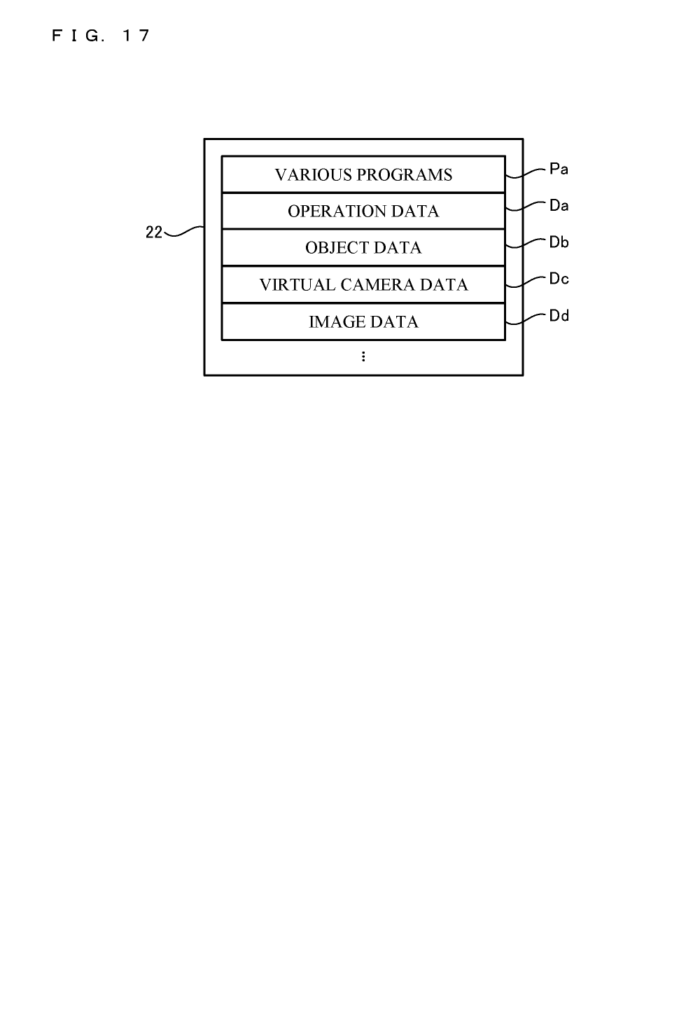

Next, processes that are executed in the information processing apparatus 2 will be described in detail. Firstly, main data that is used in the processes executed in the information processing apparatus 2 will be described with reference to FIG. 17.

As shown in FIG. 17, the data storage area of the storage unit 22 stores operation data Da, object data Db, virtual camera data Dc, image data Dd, and the like. It should be noted that the storage unit 22 stores data needed in processes such as data used in an application that is executed, in addition to the data shown in FIG. 17. In addition, the program storage area of the storage unit 22 stores various programs Pa included in an information processing program (game program) and the like.

The operation data Da indicates operation information about an operation performed on the input apparatus 3 by the user. For example, operation data indicating that the input apparatus 3 has been operated (data indicating operations performed on the operation buttons 31 and 32, and data based on the result of detection in the mouse sensor 34) is acquired for each unit time (e.g., 1/60 seconds) for which the information processing apparatus 2 executes a process, and is stored into the operation data Da in response to the acquisition, so that the operation data Da is updated. In addition, operation data that is detected by an inertial sensor (the angular velocity sensor 35, the acceleration sensor 36) when an operation of moving the input apparatus 3 is performed is also acquired for each unit time (e.g., 1/60 seconds) in which the information processing apparatus 2 executes a process, and is stored into the operation data Da in response to the acquisition, so that the operation data Da is updated.

The object data Db indicates the position, orientation, motion, state, display form, and the like of an object displayed on the display apparatus 4 (e.g., the object OBJ in the first and second example game processes, the cursor C in the third example game process, and the player object PO, the left hand POL, and the right hand POR in the fourth example game process).

The virtual camera data Dc indicates the position, orientation, and the like of a virtual camera.

The image data Dd is for displaying an image of the virtual space on the display apparatus 4.

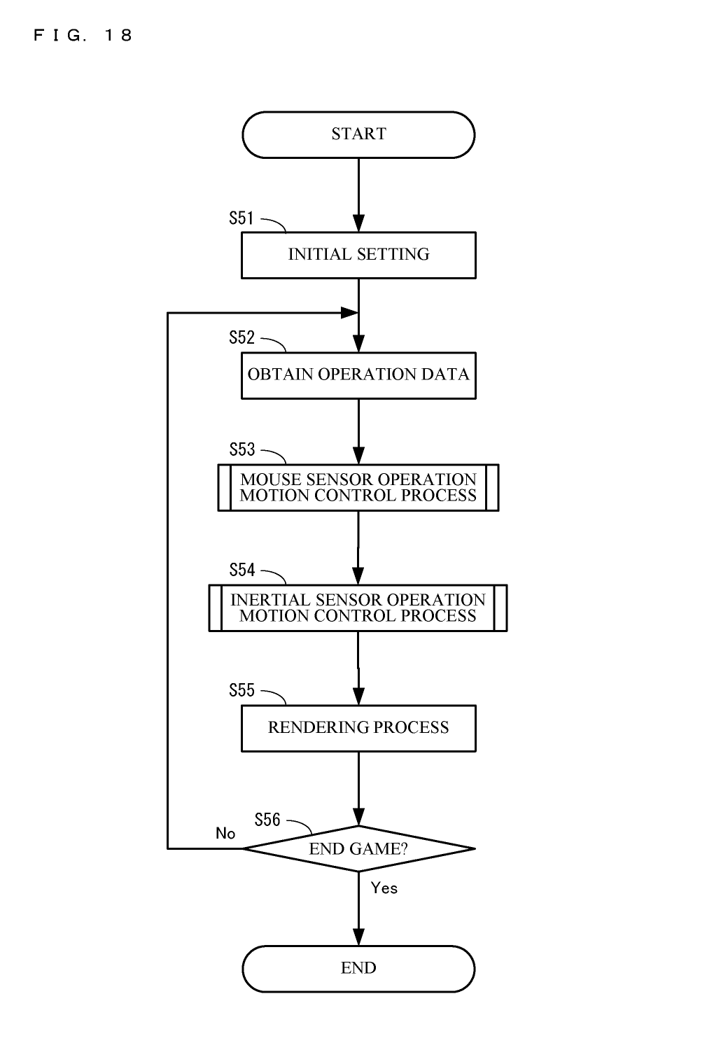

Next, processes that are executed in the information processing apparatus 2 will be described in detail with reference to FIGS. 18 to 20. It should be noted that in the flowcharts shown in FIGS. 18 to 20, the first example game process of the information processing system 1 will be mainly described, and other processes that are not directly involved with that process and the other example game processes will not be described in detail. In addition, in FIGS. 18 to 20, each step that is executed by the control unit 21 is abbreviated to “S”.

In the present example, a series of processes shown in FIGS. 18 to 20 is executed by the control unit 21 (CPU) executing a game program and the like stored in the program storage unit 23. It should be noted that the timing with which the processes of FIGS. 18 to 20 are started is not particularly limited. At this time, all or a portion of the game program is read from the storage unit 22 with appropriate timing, and is executed by the control unit 21. Thus, the series of processes of FIGS. 18 to 20 is started. It should be noted that the game program is assumed to be previously stored in the program storage unit 23. In another example, the game program may be acquired from a storage medium removably attached to the information processing apparatus 2, and stored into the storage unit 22, or may be acquired from another apparatus through a network, such as the Internet, and stored into the storage unit 22.

The steps of the flowcharts of FIGS. 18 to 20 are merely illustrative. The order in which the steps are executed may be changed, and another step may be executed in addition to or instead of each step, if a similar result is achieved. Although in the present example, it is assumed that each step of the flowcharts is executed by the control unit 21, all or a portion of the steps of the flowcharts may be executed by another processor or a dedicated circuit instead of the CPU of the control unit 21.

In FIG. 18, the control unit 21 sets initial settings (step S51), and proceeds to the next step. For example, the control unit 21 initially sets parameters for use in the subsequent steps. As an example, the control unit 21 sets a virtual surface that extends in a horizontal direction of a virtual space. In the case of the first example game process, the control unit 21 initially sets an object OBJ at an initial position on the virtual surface of the virtual space, and updates the object data Db.

Next, the control unit 21 obtains operation data from the input apparatus 3 and updates the operation data Da (step S52), and proceeds to the next step.

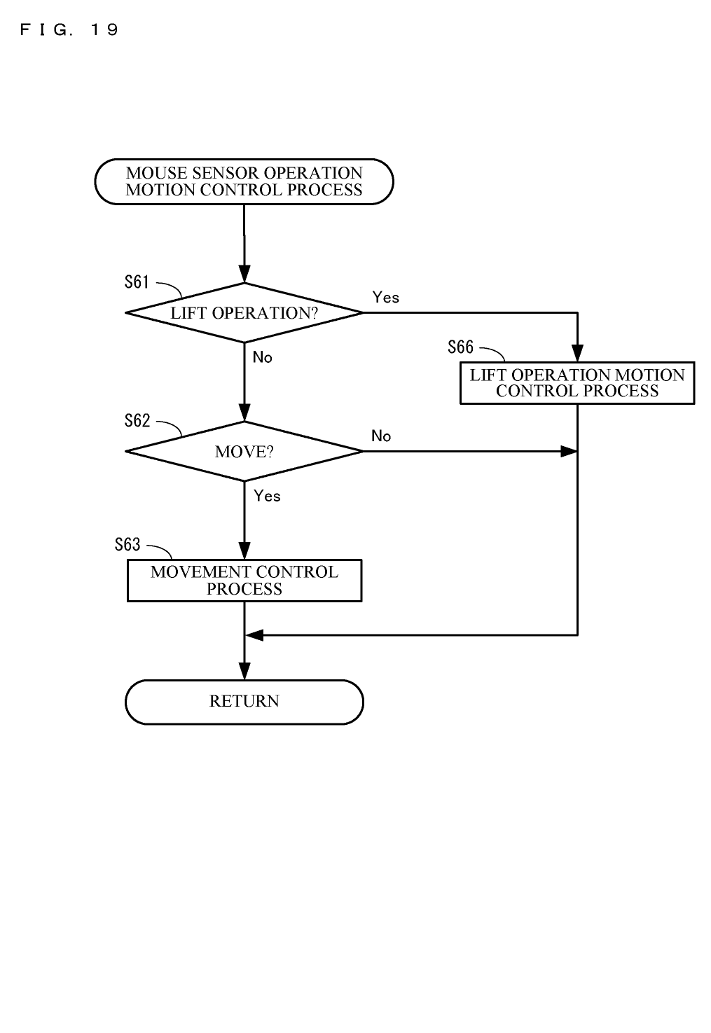

Next, the control unit 21 executes a mouse sensor operation motion control process (step S53), and proceeds to step S54. The mouse sensor operation motion control process that is executed in step S53 will be described below with reference to FIG. 19.

In FIG. 19, the control unit 21 determines whether the operation of lifting the input apparatus 3 has been performed (step S61). For example, the control unit 21 refers to the operation data Da. If an output indicating the detection of reflected light has not been received from the mouse sensor 34, the result of the determination in step S61 is positive. The output indicating the detection of reflected light may be an output including a flag indicating the detection of reflected light, or a parameter whose value is increased or decreased according to the state of light reception by the mouse sensor 34, and falls within a predetermined range (including the range of at least the predetermined value or the range of at most the predetermined value). If the operation of lifting the input apparatus 3 has not been performed, the control unit 21 proceeds to step S62. Otherwise, i.e., if the operation of lifting the input apparatus 3 has been performed, the control unit 21 proceeds to step S66.

In step S62, the control unit 21 determines whether the operation of moving the input apparatus 3 on the placement surface has been performed. If the operation of moving the input apparatus 3 on the placement surface has been performed, the control unit 21 proceeds to step S63. Otherwise, i.e., if the operation of moving the input apparatus 3 on the placement surface has not been performed, the control unit 21 ends the subroutine.

In step S63, the control unit 21 executes an object movement control process, and ends the subroutine. For example, the control unit 21 calculates a parameter related to the movement of the input apparatus 3 (e.g., a movement direction and movement distance at and over which the input apparatus 3 has been moved on the placement surface) based on the result of reflected light detected by the mouse sensor 34 according to the operation of moving the input apparatus 3 on the placement surface. Thereafter, the control unit 21 moves the object OBJ along the virtual surface in the virtual space based on the calculated parameter, and updates the object data Db. As an example, based on the movement direction and movement distance at and over which the input apparatus 3 has been moved on the placement surface, the control unit 21 moves the object OBJ along the virtual surface in the same direction as the movement direction of the input apparatus 3 and over a length corresponding to the movement distance of the input apparatus 3. In addition, when the object OBJ is moved backward on the virtual surface, the control unit 21 may execute a process of changing a state of the object OBJ according to the length of the backward movement (e.g., accumulation of movement energy), and update the object data Db.

If in step S61, it is determined that the lift operation has been performed, the control unit 21 executes a lift operation motion control process (step S66), and ends the subroutine. For example, the control unit 21 moves the object OBJ along the virtual surface, and updates the object data Db. It should be noted that the control unit 21 may refer to the object data Db, and set a parameter related to the movement of the object OBJ based on a state (e.g., the amount of accumulated movement energy) of the object OBJ.

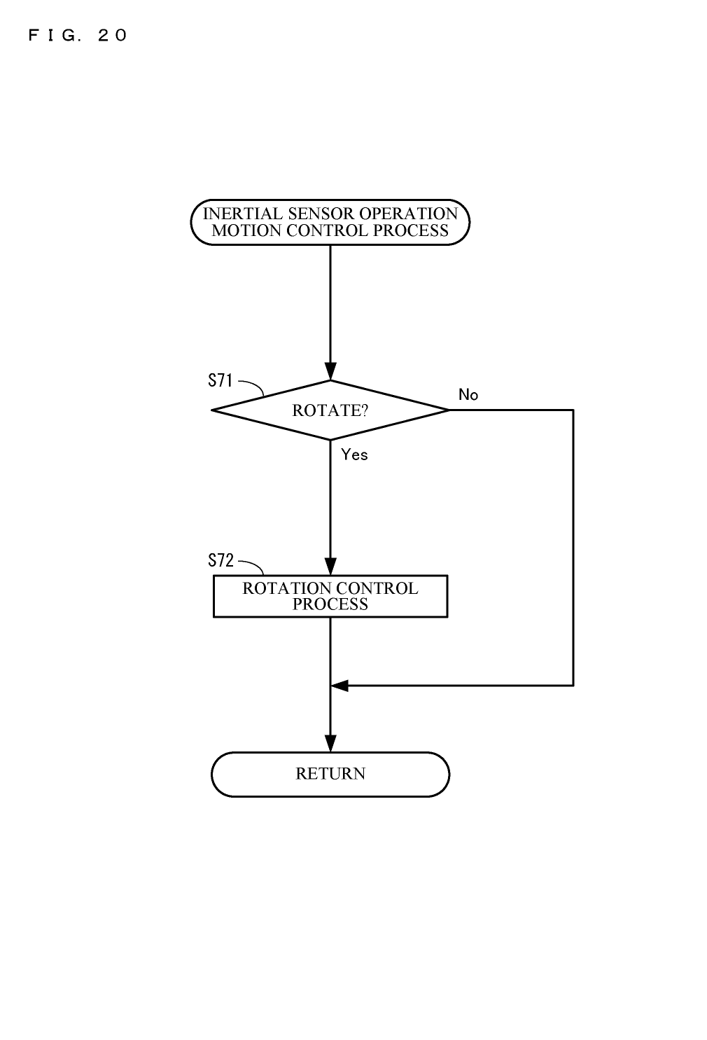

Referring back to FIG. 18, after the mouse sensor operation motion control process in step S53, the control unit 21 executes an inertial sensor operation motion control process (step S54), and proceeds to step S55. The inertial sensor operation motion control process that is executed in step S54 will be described below with reference to FIG. 20.

In FIG. 20, the control unit 21 determines whether a rotation operation of changing the orientation of the input apparatus 3 on the placement surface has been performed (step S71). For example, the control unit 21 refers to the operation data Da, and if the result of detection by the angular velocity sensor 35 indicating that the orientation of the input apparatus 3 has been changed on the placement surface has been acquired, the result of the determination in step S71 is positive. If the rotation operation has been performed, the control unit 21 proceeds to step S72. Otherwise, i.e., if the rotation operation has not been performed, the control unit 21 ends the subroutine.

In step S72, the control unit 21 executes a rotation control process, and ends the subroutine. For example, the control unit 21 changes the orientation of the object OBJ on the virtual surface according to the operation input of changing the orientation of the input apparatus 3 on the placement surface, and updates the object data Db.

Referring back to FIG. 18, after the inertial sensor operation motion control process in step S54, the control unit 21 executes a rendering process (step S55), and proceeds to the next step.

Next, the control unit 21 determines whether to end the game process (step S56). If the control unit 21 determines to continue the game process, the control unit 21 returns to and repeats step S52. If the control unit 21 determines to end the game process, the control unit 21 ends the process of the flowchart. Thereafter, the series of processes of steps S52 to S56 is repeatedly executed until the control unit 21 determines to end the game process in step S56.

It should be noted that in the flowchart, a step of executing a button operation motion control process may be added with appropriate timing (e.g., between step S52 and step S53). For example, in the step of executing the button operation motion control process, the control unit 21 refers to the operation data Da, and if the operation of pressing one of the operation buttons 31 and 32 of the input apparatus 3 or the operation of cancelling the pressing of one of the operation buttons 31 and 32 of the input apparatus 3 has been performed, the control unit 21 sets the motion of the object corresponding to the operation performed on that operation button, and updates the object data Db based on the set motion. As an example, in the case of the second example game process, the control unit 21 moves the object OBJ forward based on the amount of accumulated movement energy in response to the operation of cancelling the pressing of the operation button 31, updates the object data Db, and skips steps S53 and S54. Otherwise, i.e., if the operation of pressing the operation button 31 has been performed, the control unit 21 enables the motion control in steps S53 and S54, and sets the motion of the object OBJ in the motion control process of these steps. As another example, in the case of the fourth example game process, if the operation of pressing the operation button 31 has been performed, the control unit 21 applies a propulsive force to the player object PO by the movement of the left hand POL or the right hand POR, and updates the object data Db. Otherwise, i.e., if the pressing of the operation button 31 has been cancelled, the control unit 21 updates the object data Db without applying a force in the opposite direction due to the movement of the left hand POL or the right hand POR or a new propulsive force to the player object PO. The details of the movement control process according to the operation of moving the input apparatus 3 is changed according to a state of the object data Db. Thus, the presence or absence or details of the execution of the motion control process or the lift operation motion control process may be changed according to the state of pressing of an operation button.

Thus, with the information processing system 1 that executes the above game process, when the operation of lifting the input apparatus 3 from the placement surface is performed, the object can be moved along a virtual surface in a virtual space, and therefore, novel operation experience and amusingness can be provided. For example, in a typical operation of using a mouse, if there is not enough placement surface (work surface space) for placing the input device when an object is moved according to the operation, the operation of lifting the mouse and replacing the mouse on the placement surface at an appropriate position, and moving the mouse again from the replaced position to further move the object, is performed. In the case in which the operation of lifting the mouse is performed in order to achieve such an operation, it is necessary to maintain the position of an object that is operated using the mouse. Typically, the position of an object is not changed when the mouse is lifted. However, in the information processing system 1 that executes the above game process, when the operation of lifting the input apparatus 3 from the placement surface is performed, an object is moved without the position thereof being maintained, and therefore, novel operation experience and amusingness can be provided.

It should be noted that the input apparatus 3 may be operated not only with the input apparatus 3 held by the user with a single hand or both hands, but also with the input apparatus worn on the user’s body. As an example, in the case in which an operation is performed using two input apparatuses 3, the operation may be performed with the input apparatuses 3 worn on the user’s both legs or arms. As another example, in the case in which an operation is performed using four input apparatuses 3, the operation may be performed with the input apparatuses 3 worn on the user’s both hands and both legs.

In the foregoing, the information processes are performed in the information processing apparatus 2. Alternatively, at least a portion of the steps in the processes may be performed in another apparatus. For example, steps in the processes may be executed in cooperation with a server or another apparatus (e.g., another information processing apparatus, a game apparatus, or a mobile terminal) that can communicate with the information processing apparatus 2. Thus, processes similar to the above processes can be performed by a server or another apparatus performing a portion of the steps in the processes. The above processes may be executed by a single processor or a plurality of cooperating processors included in an information processing system including at least one information processing apparatus. In the above example, the processes shown in the flowcharts are performed by the control unit 21 of the information processing apparatus 2 executing a predetermined program. Alternatively, all or a portion of the above processes may be performed by a dedicated circuit included in the information processing apparatus 2.

Here, according to the above variation, the present example can be implemented in a so-called cloud computing system form or distributed wide-area or local-area network system form. It should be noted that, in these system forms, each of the above steps may be performed by any suitable one of the apparatuses, and the present example may be implemented by assigning the steps to the apparatuses in any suitable manner.

The order of steps, setting values, conditions for determination, etc., used in the above information process are merely for illustrative purposes, and other order of steps, setting values, conditions for determination, etc., may be used to implement the present example.

The above information processing program may be supplied to the information processing apparatus 2 not only through an external storage medium, such as an external memory, but also through a wired or wireless communication line. The program may be previously stored in a non-volatile storage device in the information processing apparatus 3. Examples of an information storage medium storing the program may include non-volatile memories, and in addition, CD-ROMs, DVDs, optical disk-shaped storage media similar thereto, flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several non-limiting example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present non-limiting example and common technical knowledge. It should be understood throughout the present specification that expression of a singular form includes the concept of its plurality unless otherwise mentioned. Specifically, articles or adjectives for a singular form (e.g., “a,” “an,” “the,” etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present non-limiting example pertain. If there is any inconsistency or conflict, the present specification (including the definitions) shall prevail.

As described above, the present example is useful as, for example, a storage medium, game system, computer-implemented method, and the like for the purpose of providing novel operation experience and amusingness.

What is claimed is:

1. One or more non-transitory computer-readable storage media having stored therein instructions that, when executed, cause one or more processors to perform operations comprising:
executing a first process of moving a first object along a virtual surface in a virtual space based on first data output according to movement of a first mouse on a placement surface; and
executing a second process of moving the first object along the virtual surface based on second data output according to lift of the first mouse from the placement surface.

2. The one or more non-transitory computer-readable storage media according to claim 1, wherein
after the first object is moved along the virtual surface in the first process, the first object is returned to a position before the movement of the first object, based on the second data, in the second process.

3. The one or more non-transitory computer-readable storage media according to claim 1, wherein
after the first object is moved along the virtual surface in the first process, the first object is returned to a range including a position before the movement of the first object, based on the second data, in the second process.

4. The one or more non-transitory computer-readable storage media according to claim 1, wherein
in the second process, the first object is moved to a position along the virtual surface based on a position where the first object is positioned at the time when the first mouse is lifted from the placement surface, based on the second data.

5. The one or more non-transitory computer-readable storage media according to claim 1, wherein
in the first process, the first object is moved on a path along the virtual surface based on the first data, and
in the second process, the first object is returned to a position on the path based on the second data.

6. The one or more non-transitory computer-readable storage media according to claim 2, wherein
in the first process, a first in-game effect is produced according to the movement of the first object, and
in the second process, the first in-game effect is not produced according to the movement of the first object.

7. The one or more non-transitory computer-readable storage media according to claim 6, wherein
the first mouse includes at least one operation button, and
the first in-game effect is produced when the operation button is being operated.

8. The one or more non-transitory computer-readable storage media according to claim 1, wherein
in the second process, the first object is moved in a direction related to an orientation that the first mouse has at the time when the first mouse is lifted from the placement surface, based on the second data.

9. The one or more non-transitory computer-readable storage media according to claim 1, wherein
the operations further comprise:
executing a third process of moving a second object along the virtual surface based on fourth data output according to movement of a second mouse on a placement surface; and
executing a fourth process of moving the second object along the virtual surface based on fifth data output according to lift of the second mouse from the placement surface.

10. The one or more non-transitory computer-readable storage media according to claim 9, wherein
the first and second objects are a portion of a third object, and
in the first and third processes, the third object is moved along the virtual surface.

11. The one or more non-transitory computer-readable storage media according to claim 10, wherein
in the second and fourth processes, the third object is not moved.

12. A game system comprising:
one or more processors;
a first mouse on a placement surface; and
one or more memories storing instructions to perform operations comprising:
executing a first process of moving a first object along a virtual surface in a virtual space based on first data output according to movement of the first mouse; and
executing a second process of moving the first object along the virtual surface based on second data output according to lift of the first mouse from the placement surface.

13. The game system according to claim 12, wherein
after the first object is moved along the virtual surface in the first process, the first object is returned to a position before the movement of the first object, based on the second data, in the second process.

14. The game system according to claim 12, wherein
in the second process, the first object is moved in a direction related to an orientation that the first mouse has at the time when the first mouse is lifted from the placement surface, based on the second data.

15. The game system according to claim 12, wherein
the operations further comprise:
executing a third process of moving a second object along the virtual surface based on fourth data output according to movement of a second mouse on a placement surface; and
executing a fourth process of moving the second object along the virtual surface based on fifth data output according to lift of the second mouse from the placement surface.

16. A computer-implemented method executable by an information processing system including at least a first mouse on a placement surface, the method comprising:
moving a first object along a virtual surface in a virtual space based on first data output according to movement of a first mouse on a placement surface; and
moving the first object along the virtual surface based on second data output according to lift of the first mouse from the placement surface.

17. The computer-implemented method according to claim 16, wherein
after the first object is moved along the virtual surface, the first object is returned to a position before the movement of the first object, based on the second data, in the second process.

18. The computer-implemented method according to claim 16, wherein
in the second process, the first object is moved in a direction related to an orientation that the first mouse has at the time when the first mouse is lifted from the placement surface, based on the second data.

19. The computer-implemented method according to claim 16, wherein
the operations further comprise:
moving a second object along the virtual surface based on fourth data output according to movement of a second mouse on a placement surface; and
moving the second object along the virtual surface based on fifth data output according to lift of the second mouse from the placement surface.
